(19) United States
(12) Patent Application Publication
(10) Pub. No.: US 2024/0229578 A9
(43) Pub. Date: Jul. 11, 2024

(54) CASING LIFTING SYSTEM

(71) Applicant: Pugh Acquisition Co., Corpus Christi, TX (US)

(72) Inventors: Michael F. D. Cadigan, Houston, TX (US); Paul Liberato, Richmond, TX (US)

(21) Appl. No.: 18/492,755

(22) Filed: Oct. 23, 2023

Related U.S. Application Data
(60) Provisional application No. 63/380,498, filed on Oct. 21, 2022.

(51) Int. Cl. E21B 19/06; B66C 1/28; B66C 1/66

(52) U.S. Cl. CPC E21B 19/06; B66C 1/28; B66C 1/66

(57) ABSTRACT

A casing lifting system includes a spreader bar, a first lifting cap, and a second lifting cap. The first lifting cap is configured to engage a first end of a first section of drilling casing, and the first lifting cap includes a first lifting lug. The second lifting cap is configured to engage a second end of the first section of drilling casing opposite the first end of the first section of drilling casing, and the second lifting cap includes a second lifting lug. In some embodiments, each of the first and second lifting caps are configured for coupling adjacent to opposing lateral ends of the spreader bar by respective first and second elastic stabilizers coupled between the first and second lifting lugs and first attachment points adjacent to the opposing lateral ends of the spreader bar.

### CROSS-REFERENCE TO RELATED APPLICATIONS

The present application claims benefit, under 35 U.S.C. 119(e), of U.S. Provisional Application No. 63/380,498, filed Oct. 21, 2022, the disclosure of which is incorporated by reference herein.

### FIELD OF THE DISCLOSURE

This disclosure relates generally to lifting drilling casing, and, more particularly, to a casing lifting system and rigging arrangement for lifting drilling casing.

### BACKGROUND

In the oil and gas industry, some of the more necessary components used in drilling operations include tubular goods, such as casing, drill pipe, and tubing. In particular, once a well has been drilled, casing is used to line and stabilize the well. Casing is typically fabricated in sections, or joints, that may be around 40 feet long and are coupled end-to-end to form longer lengths of casing, called casing strings. In various examples, a typical well may be thousands of feet deep, so it is not uncommon to use hundreds (or in some cases thousands) of sections of casing to line the well.

Tubular goods, including the numerous individual sections of casing that are typically used in drilling operations, must be transported from a fabrication facility to a well site, which may include an offshore well site, by truck, boat, and/or barge. One method of handling tubulars during the transport process is to wrap slings around the tubulars, the slings being attached to a crane or other hoisting means, for lifting of the tubulars. There is inherent risk in this type of lifting method, both to roustabouts and to the tubulars themselves. For instance, roustabouts may have to climb over, under, and/or around the staged tubulars in order to wrap or loop slings around an outer surface of the tubulars. Not only can this be a labor-intensive process, but there is a high risk of roustabouts having their hands, feet, or other body parts pinched or crushed between the tubulars, which are generally very heavy and difficult to control. Thus, existing techniques have not proved entirely satisfactory in all respects.

### SUMMARY

Systems and methods have been provided for lifting a section of drilling casing using lifting caps and a spreader bar.

In some embodiments in accordance with the present invention, a casing lifting system includes a spreader bar, a first lifting cap, and a second lifting cap. The first lifting cap is configured to engage a first end of a first section of drilling casing, and the first lifting cap includes a first lifting lug. The second lifting cap is configured to engage a second end of the first section of drilling casing opposite the first end of the first section of drilling casing, and the second lifting cap includes a second lifting lug. In some embodiments, each of the first and second lifting caps are configured for coupling adjacent to opposing lateral ends of the spreader bar by respective first and second elastic stabilizers coupled between the first and second lifting lugs and first attachment points adjacent to the opposing lateral ends of the spreader bar.

In some embodiments, each of the first and second lifting caps are further configured for coupling to an underside of the spreader bar by respective first and second slings coupled between the first and second lifting lugs and second attachment points along the underside of the spreader bar.

In some embodiments, the first section of drilling casing provides a load, and the first and second slings substantially carry the load.

In some embodiments, the second attachment points are disposed between the first attachment points adjacent to the opposing lateral ends of the spreader bar.

In some embodiments, the first and second elastic stabilizers are configured to keep the first and second lifting caps near the first and second ends of the first section of drilling casing within reach of a user.

In some embodiments, the first and second elastic stabilizers are configured to stretch to a first length when the first and second lifting caps are engaged to respective ones of the first and second ends of the first section of drilling casing, and the first and second elastic stabilizers configured to retract to a second length shorter than the first length when the first and second lifting caps are not engaged to the respective ones of the first and second ends of the first section of drilling casing.

In some embodiments, the casing lifting system further includes a third lifting cap and a fourth lifting cap. The third lifting cap is configured to engage a first end of a second section of drilling casing, and the third lifting cap includes a third lifting lug. The fourth lifting cap is configured to engage a second end of the second section of drilling casing opposite the first end of the second section of drilling casing, and the fourth lifting cap includes a fourth lifting lug. In some embodiments, each of the third and fourth lifting caps are configured for coupling adjacent to the opposing lateral ends of the spreader bar by respective third and fourth elastic stabilizers coupled between the third and fourth lifting lugs and third attachment points adjacent to the opposing lateral ends of the spreader bar.

In some embodiments, each of the third and fourth lifting caps are further configured for coupling to the underside of the spreader bar by respective third and fourth slings coupled between the third and fourth lifting lugs and the second attachment points along the underside of the spreader bar.

In some embodiments, the spreader bar further includes fourth attachment points along a topside of the spreader bar, the fourth attachment points configured for coupling to a master link assembly by respective first and second lifting slings coupled between the fourth attachment points and the master link assembly.

In some embodiments, the spreader bar includes a first segment and a second segment coupled using a splice connection.

In some embodiments, a length of the first segment is substantially equal to a length of the second segment.

In some embodiments, the spreader bar includes a spool segment coupled between a first segment and a second segment, the first segment coupled to the spool segment using a first splice connection, and the second segment coupled to the spool segment using a second splice connection.

In some embodiments, a length of the spool segment is less than a length of the first segment and less than a length of the second segment.

In some embodiments, the spreader bar includes a plurality of feet disposed along an underside of the spreader bar configured for safely landing the spreader bar.

In some embodiments, an angle between the first sling and the first section of drilling casing, and between the second sling and the first section of drilling casing, is between about 35-55 degrees.

In some embodiments, at least one of the first and second lifting caps include an annular wall portion and an end plate portion coupled to the annular wall portion at a back end of the at least one of the first and second lifting caps to define an interior space at a front end of the at least one of the first and second lifting caps within which at least one of the first and second ends of the first section of drilling casing is configured to engage the at least one of the first and second lifting caps.

In some embodiments, the end plate portion is recessed at the back end of the at least one of the first and second lifting caps to provide a lip around a perimeter of the back end of the at least one of the first and second lifting caps.

In some embodiments, the at least one of the first and second lifting caps includes a handle coupled to the end plate portion.

In some embodiments, the handle is configured for coupling to a rigid push/pull tagline.

In some embodiments, the at least one of the first and second lifting caps are configurable for installation of a sleeve lining disposed within the interior space of the at least one of the first and second lifting caps to define a modified interior space within which at least one of the first and second ends of the first section of drilling casing are configured to engage the at least one of the first and second lifting caps.

In some embodiments in accordance with the present invention, a casing lifting cap includes an annular wall portion, an end plate portion, and a lifting lug. The end plate portion is coupled to the annular wall portion near a back end of the casing lifting cap, and the annular wall portion and the end plate portion define an interior space configured to receive an end of a section of drilling casing. The lifting lug is coupled to the annular wall portion along a top surface of the casing lifting cap, and the lifting lug includes a first hole and a second hole, where the first hole is configured for connecting the casing lifting cap to a spreader bar using a sling, and where the second hole is configured for connecting the casing lifting cap to an end of the spreader bar using an elastic stabilizer.

In some embodiments, the end plate portion is recessed at the back end of the casing lifting cap to provide a lip around a perimeter of the back end of the casing lifting cap.

In some embodiments, the casing lifting cap further includes a handle, where at least one end of the handle is coupled to the recessed end plate portion.

In some embodiments, and including the casing lifting cap in combination with and connected to the sling, the sling is configured to provide a compression force that pulls the casing lifting cap onto the end of the section of drilling casing.

In some embodiments, and including the casing lifting cap in combination with and connected to the elastic stabilizer, the elastic stabilizer is configured to keep the casing lifting cap near an end of the section of drilling casing and within reach of a user.

In some embodiments, the casing lifting cap further includes a pair of lugs coupled to and protruding from the end plate portion, where each of the pair of lugs includes a first opening. In some embodiments, the casing lifting cap further includes a second opening in the end plate portion, where the second opening interposes the pair of lugs.

In some embodiments, and including the casing lifting cap in combination with a sleeve lining installed within the interior space of the casing lifting cap, the second opening is configured to receive a protruding end portion of the sleeve lining, the protruding end portion of the sleeve lining including a third opening that is substantially aligned with the first opening of each of the pair of lugs, and the aligned first and third openings are configured for insertion of a pin therethrough to secure the sleeve lining within the casing lifting cap.

In some embodiments, the casing lifting cap further includes inspection windows disposed in the end plate portion or the annular wall portion to ensure that the end of the section of drilling casing is fully engaged with the casing lifting cap.

In some embodiments, the inspection windows include a first pair of inspection windows disposed in the annular wall portion near the back end of the casing lifting cap and on opposing lateral sides of the casing lifting cap, and a second pair of inspection windows disposed in the end plate portion and adjacent to a perimeter of the end plate portion.

In some embodiments, and including the casing lifting cap in combination with a sleeve lining installed within the interior space of the casing lifting cap, the inspection windows are aligned with openings in the sleeve lining.

In some embodiments, the handle is configured for coupling to a rigid push/pull tagline.

In some embodiments in accordance with the present invention, a method of using a casing lifting system includes providing the casing lifting system, where the casing lifting system includes at least a spreader bar and a pair of lifting caps suspended from ends of the spreader bar by respective elastic stabilizers having a first stabilizer length. In some embodiments, the method further includes grasping and pulling down on the suspended pair of lifting caps to extend the respective elastic stabilizers to a second stabilizer length greater than the first stabilizer length. In some embodiments, the method further includes after extending the respective elastic stabilizers, positioning the pair of lifting caps onto opposing ends of a section of drilling casing.

In some embodiments, the method further includes removing the pair of lifting caps from the opposing ends of the section of drilling casing, where the removing causes the respective elastic stabilizers to retract to the first stabilizer length.

In some embodiments, the method further includes prior to the grasping and pulling down on the suspended pair of lifting caps, lowering the spreader bar into a position over the section of drilling casing such that the pair of lifting caps suspended from ends of the spreader bar by the respective elastic stabilizers are disposed near each of the opposing ends of the section of drilling casing.

In some embodiments, the method further includes attaching respective taglines, by a breakaway coupling connection, to a recessed end plate portion at a back end of the pair of lifting caps.

In some embodiments, the method further includes during a lift operation of the section of drilling casing, controlling the section of drilling casing using the respective taglines.

### BRIEF DESCRIPTION OF THE DRAWINGS

FIG. 1 illustrates a casing lifting system, in accordance with some embodiments.

FIG. 2 illustrates a zoomed-in view of an end portion of the casing lifting system of FIG. 1, in accordance with some embodiments.

FIG. 3 provides a perspective view of an exemplary casing lifting cap, in accordance with some embodiments.

FIG. 4 provides another perspective view of the exemplary casing lifting cap of FIG. 3, in accordance with some embodiments.

FIG. 5A illustrates a spreader bar having an optionally reconfigurable length, in accordance with some embodiments.

FIG. 5B illustrates a spreader bar having an optionally reconfigurable length, and including a spool segment, in accordance with some embodiments.

FIG. 6A illustrates a segment of a spreader bar, in accordance with some embodiments.

FIG. 6B provides an end view of the segment of FIG. 6A, and including a splice plate affixed to the end of the segment, in accordance with some embodiments.

FIG. 6C illustrates an exemplary splice connection, in accordance with some embodiments.

FIG. 6D provides another end view of the segment of FIG. 6A, and including a foot attached to the segment, in accordance with some embodiments.

FIG. 6E provides still another end view of the segment of FIG. 6A, and including a plurality of attachment points or lugs disposed at an end of the segment, in accordance with some embodiments.

FIG. 7A provides a front-end view of a lifting cap, in accordance with some embodiments.

FIG. 7B provides a back-end view of the lifting cap of FIG. 7A, in accordance with some embodiments.

FIG. 7C provides a cross-sectional view of the lifting cap of FIG. 7A, along a plane substantially parallel to a plane defined by section A-A′ of FIG. 7B, in accordance with some embodiments.

FIG. 7D provides a side view of the lifting cap of FIG. 7A, in accordance with some embodiments.

FIG. 8A provides a back-end view of a sleeve lining, in accordance with some embodiments.

FIG. 8B provides a cross-sectional view of the sleeve lining of FIG. 8A, along a plane substantially parallel to a plane defined by section B-B′ of FIG. 8A, in accordance with some embodiments.

FIG. 8C provides a side view of the sleeve lining of FIG. 8A, in accordance with some embodiments.

FIG. 9A provides an example of a casing lifting system configured to lift a drilling casing having a first length, in accordance with some embodiments.

FIG. 9B provides an example of the casing lifting system of FIG. 9A configured to lift a drilling casing having a second length less than the first length, in accordance with some embodiments.

FIG. 9C provides an example of the casing lifting system of FIG. 9A configured to lift a drilling casing having a third length greater than the first length, in accordance with some embodiments.

FIG. 10 illustrates an exemplary box end of a section of drilling casing, and including a thread protector and a lifting cap, in accordance with some embodiments.

FIG. 11 illustrates an exemplary pin end of a section of drilling casing, and including a thread protector and a lifting cap, in accordance with some embodiments.

FIG. 12 illustrates an exemplary pin end of a section of drilling casing, and including a lifting cap with a sleeve lining, in accordance with some embodiments.

FIG. 13 provides a back-end view of a lifting cap, and including a sleeve lining secured with a pin, in accordance with some embodiments.

FIG. 14 illustrates a first end view of a portion of a casing lifting system configured for lifting multiple sections of drilling casing, in accordance with some embodiments.

FIG. 15 illustrates a second end view of a portion of a casing lifting system configured for lifting multiple sections of drilling casing, in accordance with some embodiments.

FIG. 16 provides a flow chart illustrating an embodiment of a method of using a casing lifting system, in accordance with some embodiments.

Embodiments of the present disclosure may be understood by referring to the detailed description that follows. It should be appreciated that like reference numerals are used to identify like elements illustrated in one or more of the figures, wherein showings therein are for purposes of illustrating embodiments of the present disclosure and not for purposes of limiting the same.

### DETAILED DESCRIPTION

Embodiments of the present disclosure include casing lifting systems and rigging arrangement that may be used, for example, to transfer tubulars (e.g., such as drilling casing). Although not limited thereto, in some examples, the casing may be transferred between a floating vessel and an offshore drilling or production platform. Further, while various embodiments may be discussed below with reference to drilling casing, it will be understood that the casing lifting systems and rigging arrangement disclosed herein may be equally used in conjunction with other types of tubular goods, such as drill pipe and tubing.

As discussed above, a very large number of sections of casing may be used in the course of drilling operations to line and stabilize a well. Handling these sections of casing, or other tubulars, during the transport process can include wrapping slings around the casing or around several sections of casing to form a bundle. A first end of the slings may be wrapped around an outer surface of the casing near opposing ends of the casing in a direction that is substantially perpendicular to the longitudinal axis of the casing. A second end of the slings may then be attached to a crane or other hoisting means for lifting of the casing or the bundle. This type of lifting method is dangerous for roustabouts and in some cases can cause damage to the casing or bundle. For example, roustabouts may have to climb over, under, and/or around the staged casing in order to wrap or loop slings around the outer surface of the casing. Not only can this be a labor-intensive process, but there is a high risk of roustabouts having their hands, feet, or other body parts pinched or crushed between sections of casing, which are generally very heavy and difficult to control. Also, in the case of wrapping slings around several sections of casing to form a bundle, if the individual sections of casing are not packed tightly together, it is possible that the individual sections of casing may shift during a lift. In other words, unless the slings wrapped around the several sections of casing are very tightly wrapped, the slings may not have a firm grip on the bundle. In addition to the shifting that may occur during a lift, it is possible that one or more of the casings can fall out of the bundle during the lift, presenting a serious risk of injury and damage to the dropped casing(s). Thus, existing techniques have not proved entirely satisfactory in all respects.

Embodiments of the present disclosure offer advantages over the existing art, though it is understood that other embodiments may offer different advantages, not all advantages are necessarily discussed herein, and no particular advantage is required for all embodiments. For example, embodiments discussed herein include casing lifting system and rigging arrangement that may be used to transfer drilling casing or other tubulars. In various embodiments, the disclosed casing lifting system includes first and second lifting caps configured for engagement on opposing ends of a section of casing and a spreader bar with an optionally reconfigurable length to accommodate a wider range of casing lengths. Each of the lifting caps may be configured for attachment of a sling for coupling to the spreader bar and for attachment of an elastic stabilizer for coupling to ends of the spreader bar. By integrating the spreader bar and elastic stabilizers, the disclosed embodiments provide for keeping the casing lifting caps disposed at ends of the casing and within reach of roustabouts that are safely standing beside the casing (e.g., as opposed to having to climb onto the casing). In some cases, the disclosed lifting caps (i) include handles for easy and safe positioning of the casing lifting caps, (ii) are designed to fit over thread protectors, (iii) include side and/or end inspection windows to ensure that the lifting caps are fully engaged on an end of the casing, and (iv) can include an integrated polymer sleeve lining within the lifting cap, in some examples. In various embodiments, ends of the lifting caps are also configured to provide hands-free lifting (e.g., using tangle resistant taglines) and are push stick friendly (e.g., by inclusion of a recessed lip at ends of the lifting caps). Further, the spreader bar may include feet disposed along an underside of the spreader bar that provide for landing the spreader bar without damaging the rigging or having the spreader bar roll to one side. Generally, the present disclosure provides a casing lifting system and rigging arrangement that enhances safety (e.g., by eliminating the need for roustabouts to climb up onto staged casing and by providing numerous other inherent safety features) and overall efficiency. Additional details of embodiments of the present disclosure are provided below, and additional benefits and/or other advantages will become apparent to those skilled in the art having benefit of the present disclosure.

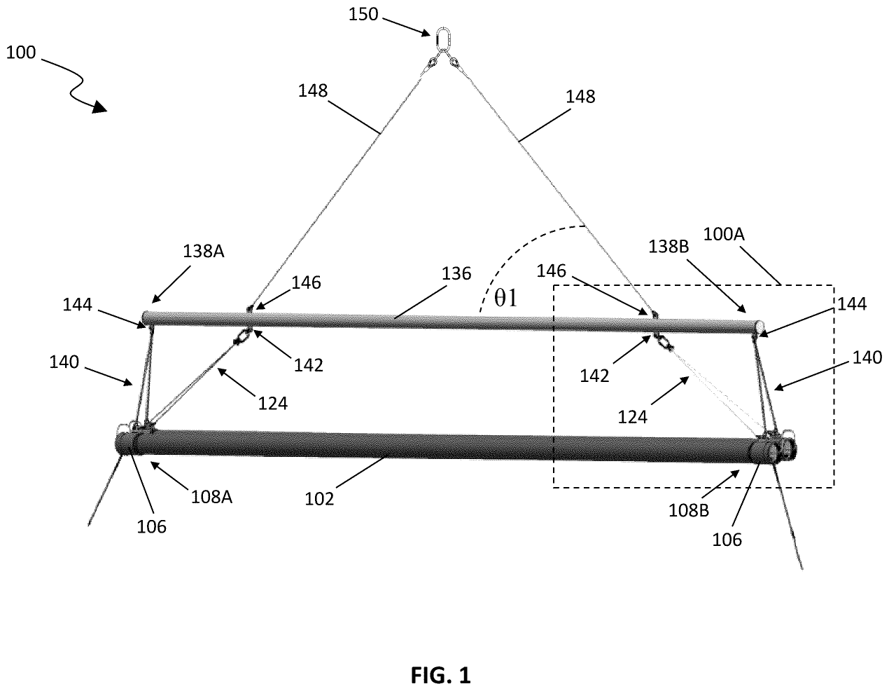

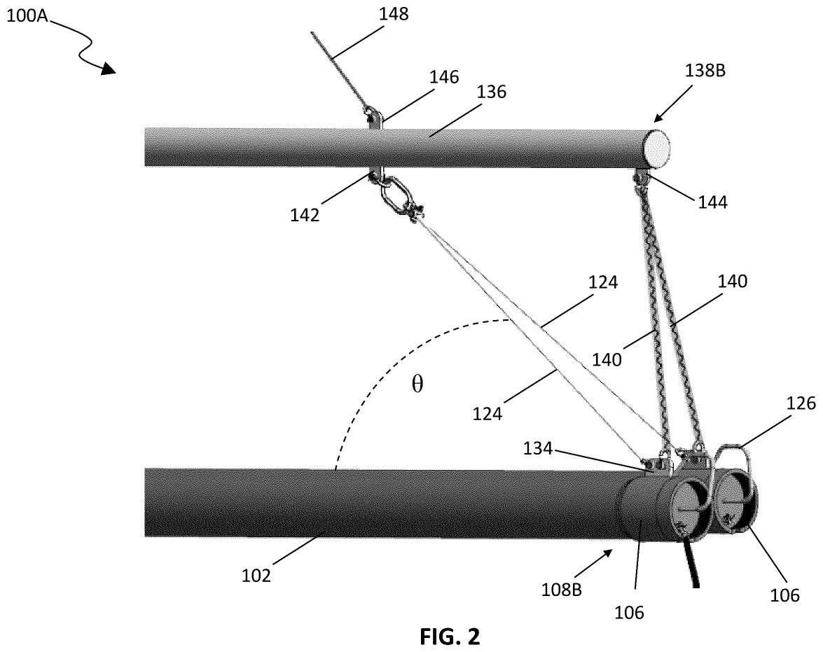

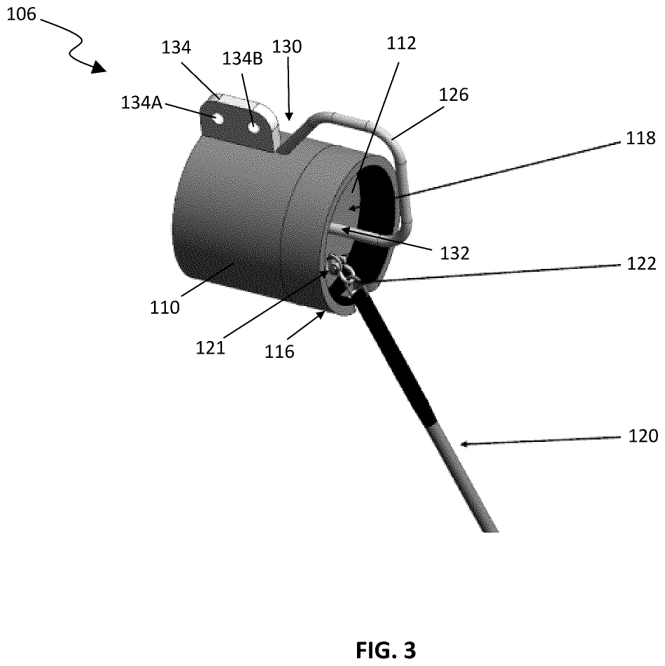

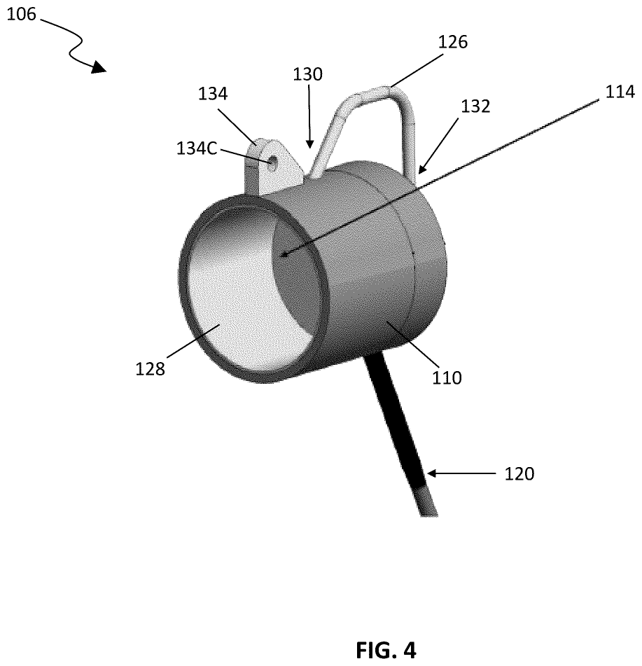

Reference is now made to FIGS. 1-4, where FIG. 1 illustrates a casing lifting system 100, in accordance with some embodiments of the present disclosure, FIG. 2 illustrates a zoomed-in view of an end portion 100A of the casing lifting system 100 shown in FIG. 1, FIG. 3 provides a first perspective view of an exemplary casing lifting cap 106 that may be used as part of the casing lifting system 100 and illustrating an end portion of the lifting cap, and FIG. 4 provides a second perspective view of the exemplary casing lifting cap 106 illustrating an interior portion of the lifting cap. The casing lifting system 100 is configured for lifting one section of drilling casing 102, or multiple sections of drilling casing 102 simultaneously. While two sections of drilling casing 102 are shown in the example of FIGS. 1 and 2, it will be understood that the casing lifting system 100 may be used for lifting different numbers of sections of drilling casing 102 (e.g., such as one, three, or other number of sections). Regardless of the number of sections of casing 102 to be lifted, each section of casing 102 may be coupled to, and lifted, using the casing lifting caps 106, as described in more detail below. In various examples, a total number of sections of casing 102 that may be lifted may depend on an outer diameter (OD), weight, or other properties of the casing 102 to be lifted. In general, the casing lifting system 100 may be used for lifting any of a variety of casing types such as conductor casing, surface casing, intermediate casing, casing liner, and production casing, or other suitable tubular goods. Such casing may include various sizes, length ranges, weight, grade, and coupling types. By way of example, the casing lifting system 100 may be used for lifting casing having an outside diameter (OD) in a range between 4½″ and 6⅝″, between 7″ and 9⅝″, or between 10¾″ and 20″, although other sizes are possible. Further, a length range for the sections of drilling casing 102 may be in a range of about 20-45 feet, in some cases.

As shown in FIGS. 1 and 2, first and second lifting caps 106 are slidably seated on and engage first and second ends 108A, 108B (e.g., which may include a box end and a pin end), respectively, of the section of drilling casing 102. As such, the first and second lifting caps 106 may have an interior diameter (ID) that is slightly larger than the OD of the section of drilling casing 102 over which they are positioned. In various examples, the casing lifting caps 106 disposed at the first and second ends 108A, 108B of the section of drilling casing 102 may be the same or they may be different. With reference to FIGS. 3 and 4, the first and second casing lifting caps 106 each include an annular wall portion 110 and an end plate portion 112 coupled to the annular wall portion 110 near a back end of the lifting caps 106, such that an interior space 114 is defined, where the interior space 114 is accessible via a front end of the lifting caps, and within which an end of the sections of drilling casing 102 may be positioned. At the back end of the lifting caps 106, the annular wall portion 110 may extend beyond the coupled end plate portion 112 to define a lip 116 around a perimeter of the back end of the lifting caps 106. Stated another way, the end plate portion 112 is recessed at the back end of the lifting caps 106 to provide the lip 116 around the perimeter of the back end of the lifting caps 106, where the lip 116 and the recessed end plate portion 112 define a recess 118. In some embodiments, the recessed end plate portion 112, and the resulting recess 118, enables a user to manipulate a suspended load with a rigid push/pull stick or tagline 120, thereby enabling hands-free manipulation of the load. In an example, a rigid push/pull tagline 120 may be coupled to the back end of the lifting cap 106 by a connector 122 (e.g., such as a D-ring connector or another suitable connector) coupled to a shackle 121 attached to the recessed end plate portion 112 at the back end of the lifting cap 106. The coupling connection between the rigid push/pull tagline 120 and the back end of the lifting cap 106 (e.g., via the connector 122) may be designed to be a weak link such that while a load is suspended, the lifting cap 106 will be pulled onto ends of the sections of drilling casing 102 by a sling 124 (e.g., such as a steel cable) that provides a compression force that is stronger than a force that the connector 122 can withstand before breaking/disconnecting. This feature, which may be referred to as a breakaway tagline, will protect against the lifting caps 106 being pulled off in the event that the tagline becomes snagged or otherwise stuck.

As previously noted, the lifting caps 106 may also include a handle 126 for easy and safe positioning of the casing lifting caps 106 (e.g., between loads) and an optional integrated polymer sleeve lining 128 within the lifting cap 106, in some cases. By using the optional polymer sleeve lining 128, a modified interior space within the lifting cap 106 may be defined. In some embodiments, a first end 130 of the handle 126 may be coupled to an outer surface of the annular wall portion 110 along a top surface of the lifting caps 106, and a second end 132 of the handle 126 may be coupled to an outer surface of the recessed end plate portion 112, thereby defining a space for convenient grasping. Thus, a user may use the handle 126 to install the lifting caps 106 by slidably engaging the lifting caps 106 onto ends 108A, 108B of the section of drilling casing 102, to remove the lifting caps 106 from the section of drilling casing 102, or to otherwise position the lifting caps 106. While not limited thereto, in at least one example, the handle 126 may include a first bend of about 45 degrees, a second bend of about 90 degrees, and a third bend of about 90 degrees between the first end 130 of the handle 126 and the second end 132 of the handle 126. The lifting caps 106 also include a lifting lug 134 coupled to the outer surface of the annular wall portion 110 along a top surface of the lifting caps 106. As shown in FIG. 3, the lifting lug 134 may include a first hole 134A (or first coupling joint 134A) for connecting the lifting cap 106 to a spreader bar 136 using the sling 124 to provide the compression force that pulls the lifting cap 106 onto the end (e.g., such as the first and second ends 108A, 108B) of the section of drilling casing 102, and a second hole 134B (or second coupling joint 134B) for connecting the lifting cap 106 to an end 138A, 138B of the spreader bar 136 using an elastic stabilizer 140 (e.g., such as a bungee cord, coiled bungee cord, or other suitable elastic cable, cord, or similar) to keep the casing lifting caps 106 disposed at ends 108A, 108B of the drilling casing 102 and within reach of roustabouts that are safely standing beside the casing. Stated another way, when the casing lifting cap 106 is not engaged with the end of the section of drilling casing 102, the elastic stabilizer 140 keeps the casing lifting caps 106 suspended from ends (e.g., such as ends 138A, 138B) of the spreader bar and within reach of roustabouts. In some cases, the first hole 134A (or first coupling joint 134A) may be larger than the second hole 134B (or second coupling joint 134B) in order to accommodate a larger and higher capacity shackle configured for coupling to the first hole 134A (or first coupling joint 134A). In other examples, as shown in FIG. 4, the lifting lug 134 may include a single hole 134C (or single coupling joint 134C) for coupling to both the sling 124 and the elastic stabilizer 140. In such an example, the hole 134C may be larger than either of the holes 134A or 134B in order to accommodate coupling of both the sling 124 and the elastic stabilizer 140.

In various examples, the sleeve lining 128 may be designed to protect threads on the sections of drilling casing 102, for instance, in cases where the drilling casing 102 does not already include a separate thread protector. To be sure, in some examples, the sleeve lining 128 may be used even when the drilling casing 102 already includes a thread protector. Whether or not the sleeve lining 128 is used, the lifting cap 106 or lifting cap 106 with sleeve lining 128 is designed to fit over ends of the drilling casing 102. Stated another way, the lifting cap 106 or lifting cap 106 with sleeve lining 128 may have an interior diameter (ID) that is slightly larger than an outer diameter (OD) of the length of drilling casing 102 on which they are positioned, or that is slightly larger than an outer diameter (OD) of a separate thread protector already installed on an end of the drilling casing 102. As such, in various embodiments, the lifting cap 106 or lifting cap 106 with sleeve lining 128 may be installed onto the end of the drilling casing 102 such that there is some play between the lifting cap 106 or lifting cap 106 with sleeve lining 128 and the end of the drilling casing 102.

Generally, differently sized lifting caps 106 may be used for differently sized sections of drilling casing 102 (e.g., sections of drilling casing 102 having different OD). However, in some cases, the polymer sleeve lining 128 may be designed with different thicknesses such that a lifting cap 106 of a given size may be used for different size sections of drilling casing 102. For instance, a thinner sleeve lining 128 may be swapped out for a thicker sleeve lining 128 and vice-versa to modify the interior diameter (ID) of the lifting cap 106 within which an end of a section of drilling casing 102 of a different size may be positioned. As one example, consider a drilling casing 102 with an outer diameter ‘OD1’ onto which a lifting cap 106 with an inner diameter ‘ID1’ and sleeve lining 128 with thickness ‘T1’ may be securely positioned. Continuing with this example, consider that a user would like to move the lifting cap 106 from the drilling casing 102 with the outer diameter ‘OD1’ to another drilling casing 102 having an outer diameter ‘OD2’ (less than ‘OD1’). In an embodiment, the user may simply swap out the sleeve lining 128 such that a sleeve lining 128 with thickness ‘T2’ (greater than ‘T1’) is inserted within the same lifting cap 106 having the inner diameter ‘ID1’. As a result, the lifting cap 106 with the inner diameter ‘ID1’ and sleeve lining 128 with thickness ‘T2’ can now be securely positioned onto the drilling casing 102 having the smaller outer diameter ‘OD2’. In another case, the same lifting cap 106 with the inner diameter ‘ID1’ may be positioned onto yet another drilling casing 102 having an outer diameter ‘OD3’ (greater than ‘OD1’). In this example, the user may again swap out the sleeve lining 128 such that a sleeve lining 128 with thickness ‘T3’ (less than ‘T1’) is inserted within the lifting cap 106 having the inner diameter or the sleeve lining 128 may simply be removed. As a result, the lifting cap 106 with the inner diameter ‘ID1’ and sleeve lining 128 with thickness ‘T3’ (or without the sleeve lining 128) can now be securely positioned onto the drilling casing 102 have the larger outer diameter ‘OD3’.

In operation, a section of drilling casing 102 may be lifted by the first and second lifting caps 106 that are slidably engaged on end portions 108A, 108B of the section of drilling casing 102. In an example, the first hole 134A (or first coupling joint 134A) of the lifting lug 134 on each of the first and second lifting caps 106 may be used to connect each of the first and second lifting caps 106 to the spreader bar 136 using respective slings 124 coupled between first and second attachment points or lugs 142 along an underside of the spreader bar 136 and each of the first and second lifting caps 106 installed on respective end portions 108A, 108B of the drilling casing 102. When lifting multiple sections of casing 102, in some embodiments and as shown in FIGS. 1-2, slings 124 that are coupled to lifting caps 106 attached to separate sections of casing 102, but at a same side of the separate sections of casing 102 (e.g., at the same end portion 108A or 108B), may be coupled to the same attachment point or lug 142 along the underside of the spreader bar 136. A sling angle θ, which is the angle between a respective sling 124 and section of drilling casing 102, may be less than about 55 degrees in order to provide the compression force that pulls the lifting cap 106 onto the end of the drilling casing 102 for a safe lift. In some cases, the sling angle θ may be between about 35 degrees and 55 degrees.

In furtherance of this example, the second hole 134B (or second coupling joint 134B) of the lifting lug 134 on each of the first and second lifting caps 106 may be used to connect each of the first and second lifting caps 106 adjacent to opposing ends 138A, 138B of the spreader bar 136 using respective elastic stabilizers 140 coupled between first and second attachment points or lugs 144 along the underside of the spreader bar 136 at each end 138A, 138B of the spreader bar 136 and each of the first and second lifting caps 106 installed on respective end portions 108A, 108B of the drilling casing 102. In some embodiments, and because the elastic stabilizers 140 are not configured to carry the load (e.g., provided by the drilling casing 102), first and second attachment points or lugs 144 need not be disposed along the underside of the spreader bar 136. For instance, as merely one example, the first and second attachment points or lugs 144 may be disposed along sides of the spreader bar 136. When lifting multiple sections of casing 102, in some embodiments and as shown in FIGS. 1-2, elastic stabilizers 140 that are coupled to lifting caps 106 attached to separate sections of casing 102, but at a same side of the separate sections of casing 102 (e.g., at the same end portion 108A or 108B), may be coupled to the same attachment point or lug 144 along the underside of the spreader bar 136. In other examples, the elastic stabilizers 140 that are coupled to lifting caps 106 attached to the separate sections of casing 102, but are on the same side of the separate sections of casing 102 (e.g., at the same end portion 108A or 108B), may be coupled to separate attachment points or lugs along the underside of the spreader bar 136, the separate attachment points or lugs being disposed at the same end 138A or 138B of the spreader bar 136.

When the lifting caps 106 are engaged on the end portions 108A, 108B of the drilling casing 102, the elastic stabilizers 140 are extended or stretched to a first stabilizer length. The elastic stabilizers 140, as previously noted, are used to keep the casing lifting caps 106 disposed near ends 108A, 108B of the drilling casing 102. More specifically, when a lifting cap 106 is removed from an end 108A, 108B of the drilling casing 102 (e.g., such as between lifts), the elastic stabilizer 140 will partially retract, together with the removed lifting cap 106 to which it is coupled, thereby keeping the lifting cap 106 disposed near the end of the drilling casing 102 and within reach of roustabouts. In some cases, the elastic stabilizer 140 may retract to a second stabilizer length that is about half the first stabilizer length. To further assist with keeping the casing lifting caps 106 disposed at ends 108A, 108B of the drilling casing 102, and in some embodiments, the spreader bar 136 may have a length that is comparable to the length of the drilling casing 102. Thus, by way of example, the spreader bar 136 may be fabricated to have a length in a range of about 20-45 feet, similar to the available lengths of drilling casing 102. This may be referred to as an extended spreader bar. In some embodiments, the spreader bar 136 has a fixed length, in contrast to the reconfigurable length spreader bar 200, discussed below.

The spreader bar 136 may further have first and second attachment points or lugs 146 along a topside of the spreader bar 136, the first and second attachment points of lugs 146 configured for attachment to respective lifting slings 148 (collectively providing a symmetric pair of lifting slings 148), and each of the respective lifting slings 148 is further coupled to a master link assembly 150. In various embodiments, a crane, hoist, or other lifting machine coupled to the master link assembly 150 may thus be used to lift the spreader bar 136 and the one or more sections of drilling casing 102 coupled to an underside of the spreader bar 136. In some embodiments, an angle θ1 between a respective lifting sling 148 (coupled to the topside of the spreader bar 136) and the top surface of the spreader bar 136 is about 45 degrees.

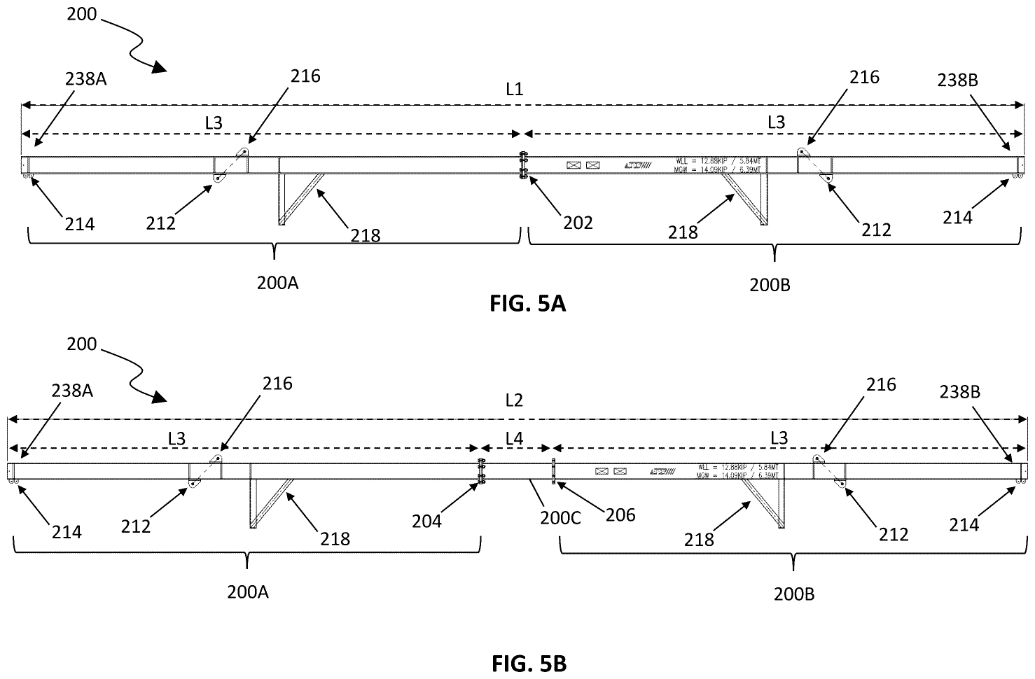

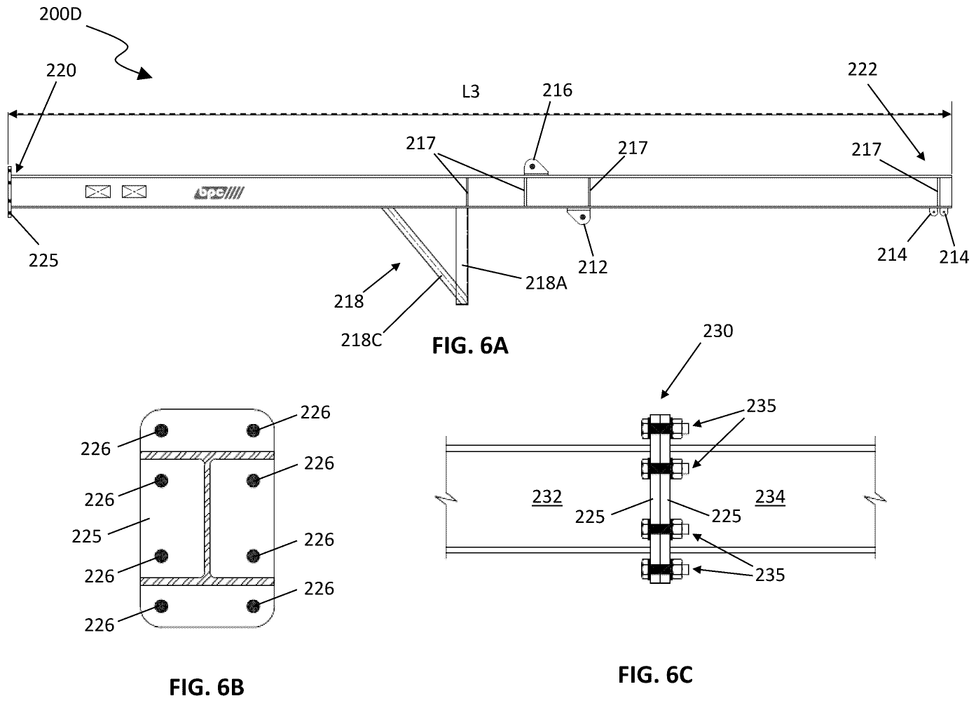

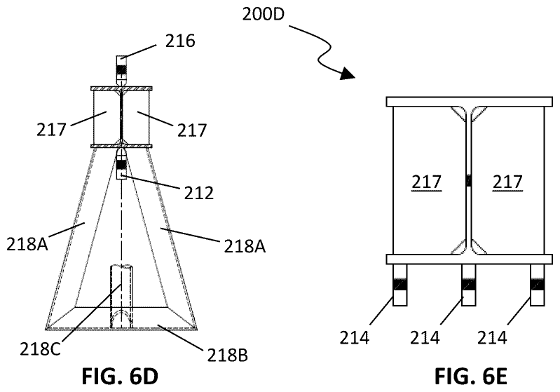

Turning now to FIGS. 5A-5B and 6A-6E, illustrated therein are embodiments of a spreader bar 200 having an optionally reconfigurable length to accommodate a wider range of drilling casing (e.g., such as the drilling casing 102). It will be understood that the spreader bar 200 may be implemented as part of the casing lifting system 100, described above. Thus, one or more aspects discussed above with reference to the casing lifting system 100 may also apply to the discussion of the spreader bar 200. In the illustrated example, the spreader bar 200 may be fabricated using an I-beam, although other embodiments are possible, such as forming the spreader bar 200 using a cylindrical bar (e.g., as shown for the spreader bar 136), a rectangular bar, a square bar, an H-beam, or other type of beam or structural member. It is also noted that while the spreader bar 136 of FIGS. 1-2 is illustrated as including a cylindrical bar, other embodiments are likewise possible, such a forming the spreader bar 136 using an I-beam, a rectangular bar, a square bar, an H-beam, or other type of beam or structural member.

As shown in FIG. 5A, the spreader bar 200 includes a first segment 200A and a second segment 200B coupled using a splice connection 202 to join the first segment 200A and the second segment 200B to provide the spreader bar 200 composed of a continuous structural element. As shown in FIG. 5B, the spreader bar 200 includes the first segment 200A, the second segment 200B, and a spool segment 200C coupled between the first and second segments 200A, 200B to increase a length of the spreader bar 200 (e.g., as compared to the example of FIG. 5A, where no spool segment 200C is used). The first segment 200A is coupled to a first end of the spool segment 200C using a first splice connection 204, and the second segment 200B is coupled to a second end of the spool segment 200C using a second splice connection 206. Thus, the coupled first segment 200A, second segment 200B, and spool segment 200C provide the spreader bar 200 composed of a continuous structural element, where the spreader bar of FIG. 5B has a length ‘L2’ that is greater than a length ‘L1’ of the spreader bar 200 of FIG. 5A.

Generally, a length ‘L3’ of each of the first and second segments 200A, 200B may be substantially equal to each other. In some embodiments, the length ‘L3’ may be in a range of about 10-22.5 feet, such that the length ‘L1’ (without the spool segment 200C) may be in a range of about 20-45 feet. In at least one example, the length ‘L’ may be equal to about 19.5 feet, such that the length ‘L1’ (without the spool segment 200C) may be equal to about 39 feet. In some examples, a length ‘L4’ of the spool segment 200C may be in a range of about 1-3 feet, such that the length ‘L2’ (with the spool segment 200C) may be in a range of about 21-46 feet (e.g., when the length ‘L4’ is equal to 1 foot) or in a range of about 23-48 feet (e.g., when the length ‘L4’ is equal to 3 feet). In at least one example, the length ‘L4’ is equal to about 3 feet and the length ‘L3’ is equal to about 19.5 feet, such that the length ‘L1’ (with the spool segment 200C) is equal to about 42 feet.

As shown in FIGS. 5A and 5B, the spreader bar 200 includes ends 238A, 238B, similar to the ends 138A, 138B, respectively, of the spreader bar 136. Like the ends 138A, 138B, the ends 238A, 238B include attachment points or lugs 214 disposed along an underside of the spreader bar 200 to which elastic stabilizers (e.g., such as the elastic stabilizers 140) may be coupled for connection to a lifting cap (e.g., such as the lifting caps 106). The spreader bar 200 also includes attachment points or lugs 212 (similar to the attachment points or lugs 142) disposed along the underside of the spreader bar 200 to which respective slings (e.g., such as the slings 124) may be coupled for connection to the lifting cap (e.g., such as the lifting caps 106).

Further, the spreader bar 200 includes attachment points or lugs 216 (similar to the attachment points or lugs 146) disposed along a topside of the spreader bar 200 to which respective lifting slings (e.g., such as the slings 148) may be coupled for connection to a master link assembly (e.g., such as the master link assembly 150). In some embodiments, the spreader bar 200 also includes feet 218 that provide for landing the spreader bar 200 (e.g., on the ground, on a boat deck, or on an offshore drilling or production platform) without damaging the rigging or having the spreader bar 200 roll or tip to one side. In some embodiments, and as more clearly visible in FIG. 6A, plates 217 (e.g., such as steel plates) may be attached (e.g., by welding) to the flange and/or web on either side of the spreader bar 200 I-beam to provide more structural support and strengthen the spreader bar 200.

FIG. 6A illustrates a segment 200D of a spreader bar, where the segment 200D may include either of the first or second segments 200A, 200B of the spreader bar 200, as described above. As shown, the segment 200D has a first end 220 and a second end 222 at opposing ends of the segment 200D. In an example, the second end 222 may include either of the ends 238A, 238B of the spreader bar 200, as described above. The second end 222 may include a plurality of attachment points or lugs 214 for coupling of the elastic stabilizers. FIG. 6E provides an end view of the second end 222, which provides another view of the segment 200D and the plurality of attachment points or lugs 214 disposed at the second end 222. In the illustrated example, there are three attachment points or lugs 214 for coupling three elastic stabilizers to three lifting caps. In some cases, and due to the limited space along the underside of the segment 200D, the plurality of attachment points or lugs 214 may be staggered. For instance, and still with reference to FIG. 6E, the center attachment point or lug 214 may be staggered (e.g., spaced a greater distance from the end of the segment 200D as compared to the leftmost and rightmost attachment points or lugs 214, which may be about the same distance from the end of the segment 200D). As such, with reference to FIG. 6A, the left attachment point or lug 214 shown may be the center attachment point or lug 214 (of FIG. 6E), which is staggered from leftmost and rightmost attachment points or lugs 214 (of FIG. 6E), the leftmost and rightmost attachment points or lugs 214 being substantially aligned and collectively illustrated as the right attachment point or lug 214 in FIG. 6A. In various embodiments, the number of attachment points or lugs 214 at the second end 222 may be in a range of between 1 and 3. FIG. 6E also shows a set of plates 217 coupled to either side of the I-beam of the segment 200D.

The segment 200D additionally includes one of the two attachment points or lugs 212 of the spreader bar 200 for coupling a respective sling to a lifting cap, one of the two attachment points or lugs 216 of the spreader bar 200 for coupling a respective lifting sling to a master link assembly, and one of the two feet 218 of the spreader bar 200 for safely landing the spreader bar 200. The feet 218, also illustrated in the end view of the segment 200D of FIG. 6D, may be formed by coupling (e.g., by welding) first and second vertical members 218A to a first portion of the underside of the segment 200D and to a horizontal member 218B that couples bottom ends of the first and second vertical members 218A to each other. The horizontal member 218B may further be coupled to a diagonal member 218C, which is further coupled to a second portion of the underside of the segment 200D.

Referring again to FIGS. 6A, the first end 220 of the segment 200D may include a splice plate 225 coupled (e.g., by welding) to the first end 220 and perpendicular to the length of the segment 200D. FIG. 6B provides an end view of the first end 220 that shows the splice plate 225 as affixed to the end of the I-beam of the segment 200D. In some embodiments, the splice plate 225 further includes a plurality of openings 226. The openings 226, in some cases, may include holes (in some cases threaded) to accommodate bolts, screws, rivets, or other suitable fastener. While the example of FIG. 6B is illustrated as having eight (8) openings 226, it will be understood that more or fewer openings 226 may equally be used (e.g., such as 4, 6, 10, or other number of openings 226). In various embodiments, the splice plate 225 attached to the segment 200D may be configured for coupling to another splice plate 225 attached to another spreader bar segment, or to another splice plate 225 attached to a spool segment (e.g., such as the spool segment 200C).

Referring to FIG. 6C, illustrated therein is an exemplary splice connection 230 that couples a first member 232 to a second member 234. The splice connection 230 may include the splice connection 202 used to join the first segment 200A and the second segment 200B, or the first and second splice connections 204, 206 used to join the spool segment 200C to each of the first segment 200A and the second segment 200B. Thus, in various cases, the first and second members 232, 234 may include different combinations of the first segment 200A, the second segment 200B, and the spool segment 200C. In a first example, where no spool segment 200C is used (as in FIG. 5A), the first member 232 may include the first segment 200A and the second member 234 may include the second segment 200B. In another example, where the spool segment 200C is used (as in FIG. 5B), the first member 232 may include the first segment 200A and the second member 234 may include the spool segment 200C, or the first member 232 may include the spool segment 200C and the second member 234 may include the second segment 200B. Regardless of the particular combination used, the first member 232 may have a first splice plate 225 coupled to an end of the first member 232, and the second member 234 may have a second splice plate 225 coupled to an end of the second member 234, where the ends of each of the first and second members 232, 234 face each other. As such, each of the splice plates 225 coupled to ends of the first and second members 232, 234 also face each other. Further, the openings 226 in each of the splice plates 225 are aligned with each other such that fasteners 235 may be used to secure the plates 225 via the openings 226, and thereby secure the first and second members 232, 234, to each other.

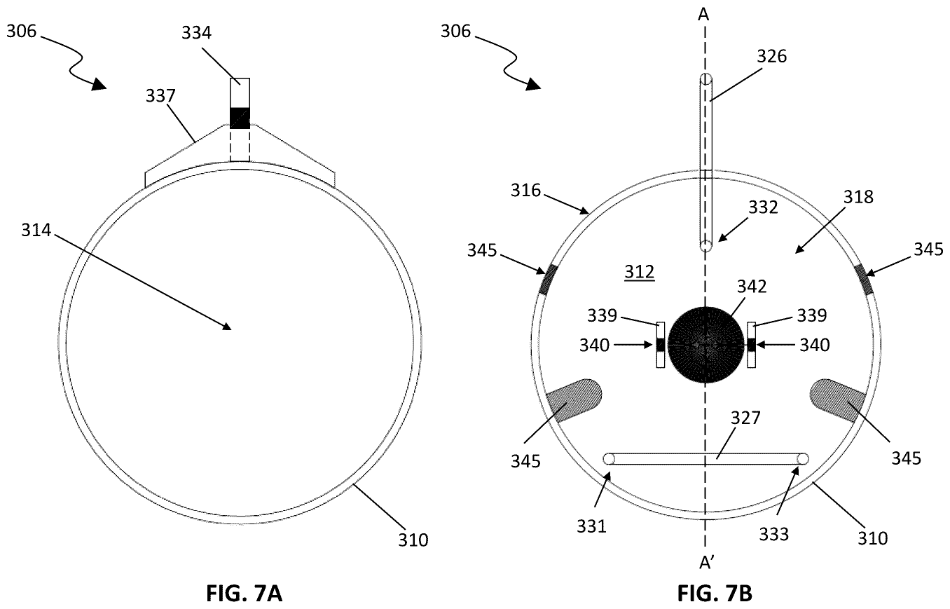

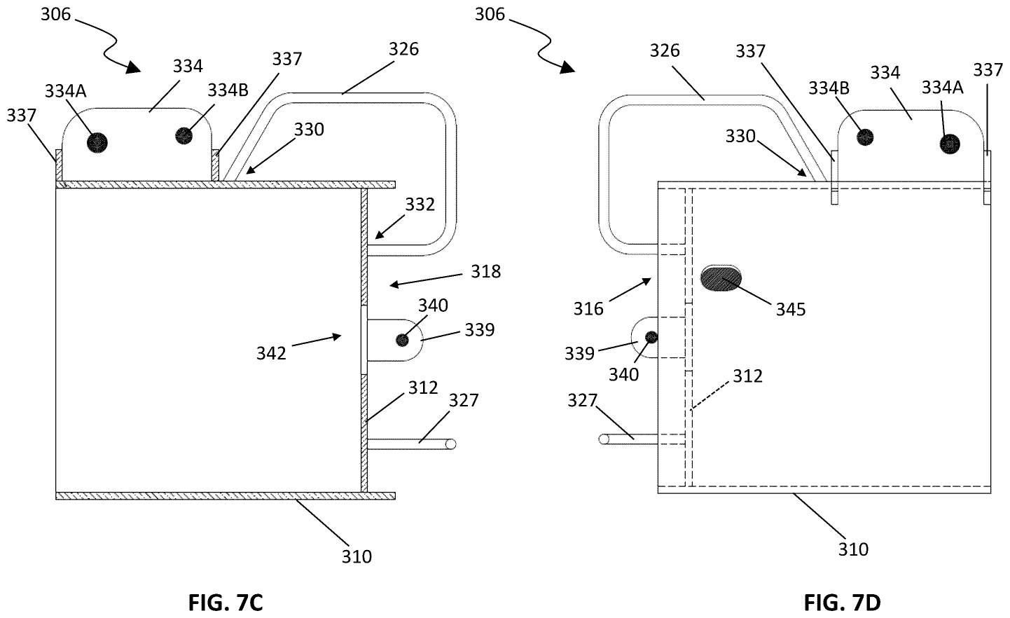

With reference now to FIGS. 7A-7D, illustrated therein are embodiments of a lifting cap 306. In accordance with some examples, FIG. 7A provides a front-end view of the lifting cap 306, FIG. 7B provides a back-end view of the lifting cap 306, FIG. 7C provides a cross-sectional view of the lifting cap 306 along a plane substantially parallel to a plane defined by section A-A′ of FIG. 7B (with position of lug 339 added for relative reference), and FIG. 7D provides a side view of the lifting cap 306. It will be understood that the lifting cap 306 may be implemented as part of the casing lifting system 100, described above. Thus, one or more aspects discussed above with reference to the casing lifting system 100 may also apply to the discussion of the lifting cap 306. In particular, and in various respects, the lifting cap 306 may be similar to the lifting cap 106, discussed with reference to FIGS. 1-4. As such, one or more aspects discussed above with reference to the lifting cap 106 may also apply to the lifting cap 306.

In some embodiments, the lifting cap 306 includes an annular wall portion 310 (similar to the annular wall portion 110) and an end plate portion 312 (similar to the end plate portion 112) coupled to the annular wall portion 310 near a back end of the lifting cap 306, such that an interior space 314 (similar to the interior space 114) is defined, where the interior space 314 is accessible via a front end of the lifting cap 306, and within which an end of a section of drilling casing (e.g., such as the drilling casing 102) may be positioned. In some embodiments, the lifting cap 306 also includes a lip 316 (similar to the lip 116) at the back end of the lifting cap 306. As such, the end plate portion 312 of the lifting cap 306 is similarly recessed at the back end of the lifting cap 306 to provide the lip 316 and define a recess 318 (similar to the recess 118).

As shown, the lifting cap 306 may also include a first handle 326 (similar to the handle 126), where a first end 330 of the first handle 326 is coupled to an outer surface of the annular wall portion 310 along a top surface of the lifting cap 306, and a second end 332 of the first handle 326 is coupled to an outer surface of an upper part of the recessed end plate portion 312, thereby defining a first space for convenient grasping. While not limited thereto, in at least one example, the first handle 326 may include a first bend of about 45 degrees, a second bend of about 90 degrees, and a third bend of about 90 degrees between the first end 330 of the first handle 326 and the second end 332 of the first handle 326. In addition, and in contrast to the lifting cap 106 previously discussed, the lifting cap 306 may further includes a second handle 327, where a first end 331 of the second handle 327 and a second end 333 of the second handle 327 are both coupled to the outer surface of a lower part of the recessed end plate portion 312, thereby defining a second space for convenient grasping. While not limited thereto, in at least one example, the second handle 327 may include a first bend of about 90 degrees and a second bend of about 90 degrees between the first and second ends 331, 333 of the handle 327. Thus, in the illustrated example, the lifting cap 306 may include two handles (the first handle 326 and the second handle 327) for easy and safe positioning of the casing lifting cap 306. Also, in some embodiments and as shown, the first handle 326 may be oriented in a first direction, and the second handle 327 may be oriented in a second direction substantially perpendicular to the first direction. In various examples, a user may choose to use the first handle 326 or the second handle 327 (e.g., depending on convenience, preference, or other factors) to install the lifting cap 306 onto ends of a section of drilling casing (e.g., such as the section of drilling casing 102), to remove the lifting cap 306 from the section of drilling casing, or to otherwise position the lifting cap 306.

The lifting cap 306 also includes a lifting lug 334 (similar to the lifting lug 134) coupled to the outer surface of the annular wall portion 310 along a top surface of the lifting cap 306. In some examples, and in order to provide additional structural support to the lifting lugs 334, support portions 337 may be coupled (e.g., by welding) to front and back ends of the lifting lug 334, and to the annular wall portion 310 along the top surface of the lifting cap 306. The lifting lug 334 may include a first hole or first coupling joint 334A (similar to the first hole or coupling joint 134A) for connecting the lifting cap 306 to a spreader bar (e.g., such as the spreader bar 136 or the spreader bar 200) using respective slings (e.g., such as the slings 124) to provide the compression force that pulls the lifting cap 306 onto an end of the section of drilling casing, and a second hole or second coupling joint 334B (similar to the second hole or coupling joint 134B) for connecting the lifting cap 306 to an end of the spreader bar (e.g., such as the spreader bar 136 or the spreader bar 200) using an elastic stabilizer (e.g., such as the elastic stabilizers 140) to keep the casing lifting caps 306 disposed at ends of the drilling casing. In some cases, the first hole or first coupling joint 334A may be larger than the second hole or second coupling joint 334B in order to accommodate a larger and higher capacity shackle configured for coupling to the first hole or first coupling joint 334A. In some examples, the lifting lug 334 may alternatively include a single hole or single coupling joint (similar to the single hole or coupling joint 134C) for coupling to both the sling (e.g., such as the slings 124) and the elastic stabilizer (e.g., such as the elastic stabilizers 140).

In some examples, the lifting cap 306 includes a pair of lugs 339 coupled (e.g., by welding) to the outer surface of a middle part of the recessed end plate portion 312 and protruding from the end plate portion 312. Each of the lugs 339 has an opening or hole 340 near an end of the lug 339, where the openings 340 in each lug 339 are substantially aligned with each other. The pair of lugs 339 are spaced apart from each other and interposed by an opening 342 in the end plate portion 312, the opening 342 disposed substantially at a center of the end plate portion 312. In some embodiments, the opening 342 may be configured to receive a protruding end portion of an optional integrated polymer sleeve lining, as described in more detail below, that is installed within the interior space 314 of the lifting cap 306. The optional integrated polymer sleeve lining may be similar, in at least some aspects, to the polymer sleeve lining 128, previously discussed. In some cases, the protruding end portion of the optional polymer sleeve lining may also have an opening that further aligns with the openings 340 in each of the lugs 339. Thus, in some examples, a pin (e.g., such as a safety pin, cotter pin, or other suitable pin) may be inserted through each of the openings 340 and the opening within the end portion of the polymer sleeve lining in order to secure the polymer sleeve lining within the lifting cap 306.

In some embodiments, the lifting cap 306 may further include inspection windows 345 (or openings 345). In an example, a first pair of inspection windows 345 may be disposed in the end plate portion 312, the first pair of inspection windows 345 disposed adjacent to a perimeter of the end plate portion 312. In addition, a second pair of inspection windows 345 may be disposed in the annular wall portion 310 near the back end of the lifting cap 306 and on opposing lateral sides of the lifting cap 306. The first pair of inspection windows 345 may be referred to as end inspection windows, and the second pair of inspection windows may be referred to as side inspection windows. In various embodiments, the side and end inspection windows may be used to ensure that the lifting cap 306 is fully engaged (fully seated) on an end of drilling casing (e.g., such as the drilling casing 102). In some cases, for instance when the optional integrated polymer sleeve lining is not used, the opening 342 in the end plate portion 312 may be used as an additional inspection window. While the illustrated examples are shown and described as having two end inspection windows (the first pair of inspection windows 345) and two side inspection windows (the second pair of inspection windows 345), it will be understood that more or fewer end inspection windows and/or side inspection windows may equally be used. For instance, in various examples, the lifting cap 306 may alternatively include 2 or 4 end inspection windows and 2 or 4 side inspection windows, 2 or 4 end inspection windows and no side inspection windows, no end inspection windows and 2 or 4 side inspection windows, or another combination of end and side inspection windows.

The lifting cap 306, like the lifting cap 106 discussed above, also provides for hands-free manipulation of a load, at least in part by way of the recessed end plate portion 312 and the resulting recess 318. In particular, and in one example, a rigid push/pull tagline (e.g., such as the rigid push/pull tagline 120) may be coupled to the second handle 327 by a connector (e.g., such as the connector 122, which may include a D-ring connector or another suitable connector). In another example, the rigid push/pull tagline may be coupled to the first handle 326 by a connector (e.g., such as the connector 122). In still another example, the rigid push/pull tagline may be coupled to the opening or hole 340 in one of the lugs 339 by a connector (e.g., such as the connector 122), if the optional integrated polymer sleeve lining is not being used. Further, while not specifically illustrated with reference to the lifting cap 306, in some cases, the rigid push/pull tagline may be coupled to the back end of the lifting cap 306 by a connector (e.g., such as the connector 122) coupled to a shackle (e.g., such as the shackle 121) attached to the recessed end plate portion 312 at the back end of the lifting cap 306. The coupling connection between the rigid push/pull tagline and the lifting cap 306 (e.g., via a connector similar to the connector 122) may be designed to be a weak link (e.g., to provide a breakaway tagline), such that while a load is suspended, the lifting cap 306 will be pulled onto ends of sections of drilling casing by a sling that provides a compression force that is stronger than a force that the connector coupling connection can withstand before breaking/disconnecting.

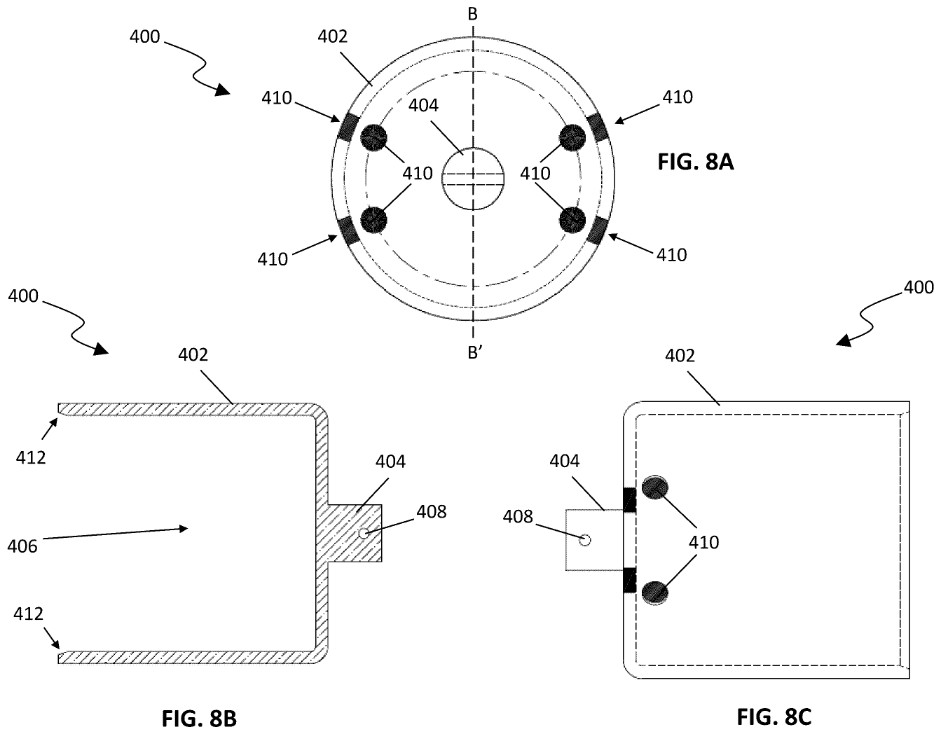

Referring to FIGS. 8A-8C, illustrated therein are embodiments of an optional polymer sleeve lining 400. In accordance with some examples, FIG. 8A provides a back-end view of the polymer sleeve lining 400, FIG. 8B provides a cross-sectional view of the polymer sleeve lining 400 along a plane substantially parallel to a plane defined by section B-B′ of FIG. 8A, and FIG. 8C provides a side view of the polymer sleeve lining 400. It will be understood that the polymer sleeve lining 400 may be implemented as part of the casing lifting system 100, described above. Thus, one or more aspects discussed above with reference to the casing lifting system 100 may also apply to the discussion of the polymer sleeve lining 400. In particular, and in various respects, the polymer sleeve lining 400 may be similar to the polymer sleeve lining 128, discussed with reference to FIG. 4. As such, one or more aspects discussed above with reference to the polymer sleeve lining 128 may also apply to the polymer sleeve lining 400.

The sleeve lining 400 (like the sleeve lining 128) may be designed to protect threads on the sections of drilling casing, for instance, in cases where the drilling casing does not already include a separate thread protector. In some examples, the sleeve lining 400 may be used even when the drilling casing already includes a thread protector. When the sleeve lining 400 is used, the lifting cap 306 with sleeve lining 400 may have an interior diameter (ID) that is slightly larger than an outer diameter (OD) of the length of drilling casing on which they are positioned, or that is slightly larger than an outer diameter (OD) of a separate thread protector already installed on an end of the drilling casing, as previously discussed. In some embodiments, sleeve lining 400 may be designed with different thicknesses such that a lifting cap 306 of a given size may be used for different size sections of drilling casing, as discussed above with reference to the sleeve lining 128.

As shown, the sleeve lining 400 may include a main liner body 402 and an end portion 404 that protrudes from a back end of the main liner body 402. The end portion 404 may also include an opening 408 for securing the sleeve lining 400 within the lifting cap 306. The front end of the main liner body 402 includes an opening that defines an interior space 406, within which an end of a section of drilling casing may be positioned (e.g., when the sleeve lining 400 is installed in a lifting cap 306). In some embodiments, the sleeve lining 400 may be installed within the interior space 314 of the lifting cap 306. When installed, the end portion 404 is configured to pass through and extend out of the opening 342 in the end plate portion 312 of the lifting cap 306. Once the sleeve lining 400 is installed, the opening 408 of the sleeve lining 400 may be aligned with the openings 340 in each of the lugs 339 of the lifting cap 306. As such, a pin (e.g., such as a safety pin, cotter pin, or other suitable pin) may be inserted through each of the openings 340 of the lugs 339 and the opening 408 of the sleeve lining 400 to secure the sleeve lining 400 within the lifting cap 306.

In some embodiments, the sleeve lining 400 may also include a plurality of openings 410 disposed on the back end and sides of the sleeve lining 400. The plurality of openings 410, by way of example, may be configured to align with the inspection windows 345 in the lifting cap 306, so that the inspection windows 345 may be used for ensuring that the lifting cap 306 is fully engaged (fully seated) on an end of drilling casing. In the illustrated examples, there may be more openings 410 in the sleeve lining 400 than there are inspection windows 345 in the lifting cap. As a result, the plurality of openings 410 in the sleeve lining 400 may be aligned to the inspection windows 345 in multiple rotational orientations of the sleeve lining 400. It is also noted that in some cases, the sleeve lining 400 may have a chamfered edge 412 around a perimeter of the main liner body 402 at the front end of the sleeve lining 400. The chamfered edge 412, by way of example, may serve to facilitate the smooth insertion of an end of a section of drilling casing.

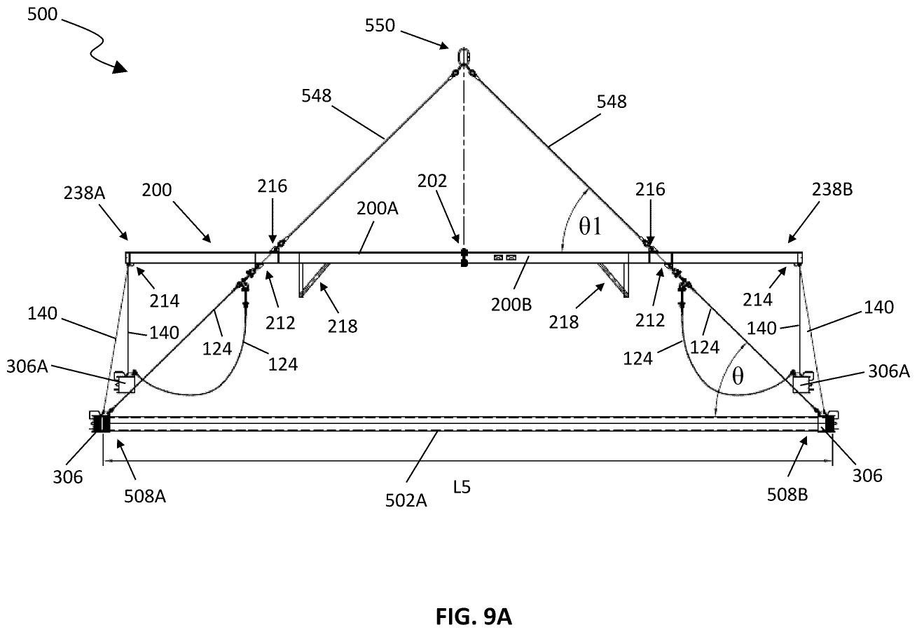

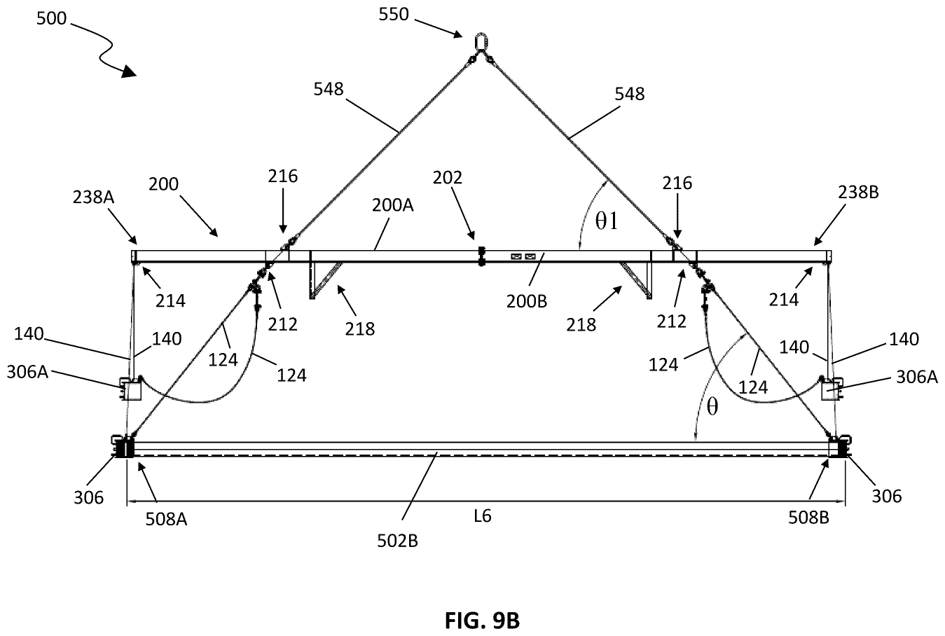

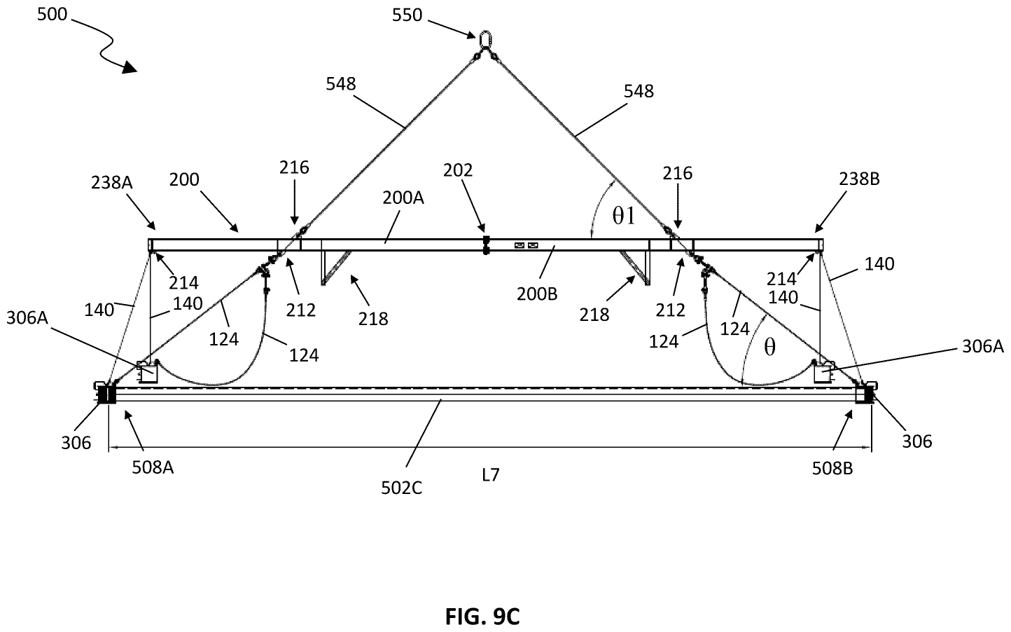

With reference to FIGS. 9A-9C and 10-15, illustrated therein are examples of a casing lifting system 500, or portions thereof, according to various aspects of the present disclosure. Generally, the casing lifting system 500 may be shown and described as including features discussed above with reference to FIGS. 5A-5B, 6A-6E, 7A-7D, and 8A-8C such as the spreader bar 200, the lifting cap 306, and the sleeve lining 400, among other features. However, it will be understood that in other embodiments, features of the casing lifting system 100 may also be used in conjunction with the casing lifting system 500. For instance, in some cases, the casing lifting system 500 may alternatively (or in some cases, additionally) use the spreader bar 136, the lifting cap 106, the sleeve lining 128, or other features described with reference to the casing lifting system 100. As merely one example, and when lifting multiple sections of casing, the casing lifting system 500 may use the spreader bar 200, the lifting cap 306 and (optionally) the sleeve lining 400 for some of the multiple sections of casing, and the lifting cap 106 and (optionally) the sleeve lining 128 for other ones of the multiple sections of casing. Other combinations of various features disclosed herein are also possible and will become evident to one skilled in the art having benefit of the present disclosure.

FIGS. 9A-9C illustrate embodiments of the casing lifting system 500, as configured to lift different lengths of drilling casing 502A, 502B, 502C (similar to the drilling casing 102, discussed above). In particular, FIG. 9A provides an embodiment of the casing lifting system 500 configured to lift the drilling casing 502A having a length 15′, FIG. 9B provides an embodiment of the casing lifting system 500 configured to lift the drilling casing 502B having a length ‘L6’ less than the length ‘L5’, and FIG. 9C provides an embodiment of the casing lifting system 500 configured to lift the drilling casing 502C having a length ‘L7’ greater than the length ‘L5’. Merely by way of example, in at least one embodiment, the length ‘L 5’ may be equal to about 42 feet, the length ‘L6’ may be equal to about 40 feet, and the length ‘L7’ may be equal to about 44 feet. More generally, and in various embodiments, a length range for the sections of drilling casing 502A, 502B, 502C may be in a range of about 20-45 feet, as previously discussed.

The casing lifting system 500, as shown in FIGS. 9A-9C, includes first and second lifting caps 306 (previously described) slidably engaging first and second ends 508A, 508B, respectively, of respective ones of the sections of drilling casing 502A, 502B, or 502C. The lifting caps 306 are coupled adjacent to ends 238A, 238B of the spreader bar 200 using elastic stabilizers 140 coupled between lugs 334 on the lifting caps 306 and attachment points or lugs 214 disposed along the underside of the spreader bar 200. The lifting caps 306 are further coupled to attachment points or lugs 212 using respective slings 124 coupled between lugs 334 on the lifting caps 306 and the attachment points or lugs 212 along the underside of the spreader bar 200. The spreader bar 200 is further coupled to a master link assembly 550 (similar to the master link assembly 150) using respective lifting slings 548 (similar to lifting slings 148) coupled between the master link assembly 550 and attachment points or lugs 216 disposed along a topside of the spreader bar 200. In various embodiments, a crane, hoist, or other lifting machine coupled to the master link assembly 550 may thus be used to lift the spreader bar 200 and respective ones of the sections of drilling casing 502A, 502B, or 502C coupled to an underside of the spreader bar 200.

In the examples of FIGS. 9A-9C, the casing lifting system 500 may be configured to lift multiple sections of drilling casing. However, in the illustrated examples, the casing lifting system 500 may not be at full capacity (e.g., lifting as many sections of drilling casing as it is able to), as evidenced by additional lifting caps 306A not connected to a section of drilling casing. As shown, however, the additional lifting caps 306A remain coupled to ends 238A, 238B of the spreader bar 200 using respective elastic stabilizers 140. Thus, even when not coupled to a section of drilling casing, the additional lifting caps 306A remain disposed near ends 508A, 508B of the drilling casing (e.g., the 502A, 502B, or 502C) and within reach of roustabouts. Additional respective slings 124 (which are not taut) may also be coupled between the additional lifting caps 306A and the attachment points or lugs 212.

As previously discussed, the sling angle 0 (the angle between a respective sling 124 and section of drilling casing 502A, 502B, 502C) may be less than about 55 degrees in order to provide the compression force that pulls the lifting caps 306 onto the ends of respective sections of drilling casing. In some cases, the sling angle θ may be between about 35 degrees and 55 degrees. In the examples of FIGS. 9A-9C, and due to the different lengths ‘L5’, ‘L7’ of the sections of drilling casing 502A, 502B, 502C, respectively, the sling angle θ will vary accordingly. For instance, the sling angle θ will increase as the length of the drilling casing is reduced, and the sling angle θ will decrease as the length of the drilling casing is increased. Thus, in the present example, the sling angle θ of the casing lifting system 500 of FIG. 9B is greater than the sling angle θ of the casing lifting system 500 of FIG. 9A (since the length of the drilling casing 502B is less than the length of the drilling casing 502A), and the sling angle θ of the casing lifting system 500 of FIG. 9C is less than the sling angle θ of the casing lifting system 500 of FIG. 9A (since the length of the drilling casing 502C is greater than the length of the drilling casing 502A). Additionally, in various embodiments and regardless of the different lengths of drilling casing, the angle θ1 between a respective lifting sling 548 and the top surface of the spreader bar 200 is about 45 degrees.

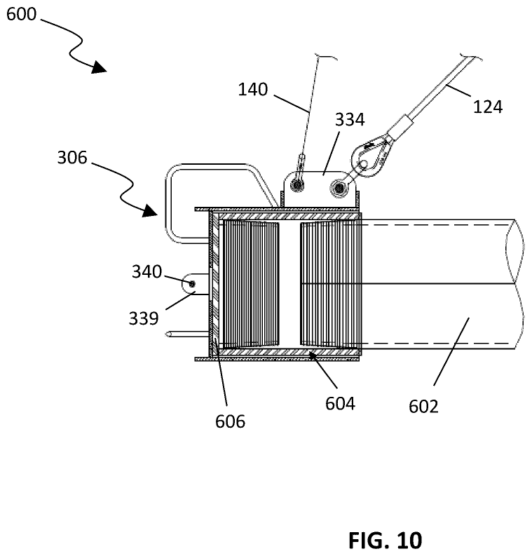

Referring to FIG. 10, illustrated therein is an exemplary box end 600 of a section of drilling casing 602, which may in some cases include the section of drilling casing 102, 502A, 502B, or 502C, discussed above. In the example shown, the box end 600 of the section of drilling casing 602 includes a casing coupling 604 and an internal thread protector 606. As shown, a lifting cap 306 (without the optional sleeve lining) is slidably engaged over the box end 600 of the section of drilling casing 602, including over the internal thread protector 606. A respective elastic stabilizer 140 and sling 124 are also coupled to the lug 334 of the lifting cap 306 engaged over the box end 600 for coupling to a spreader bar (e.g., such as the spreader bar 200), as previously discussed.

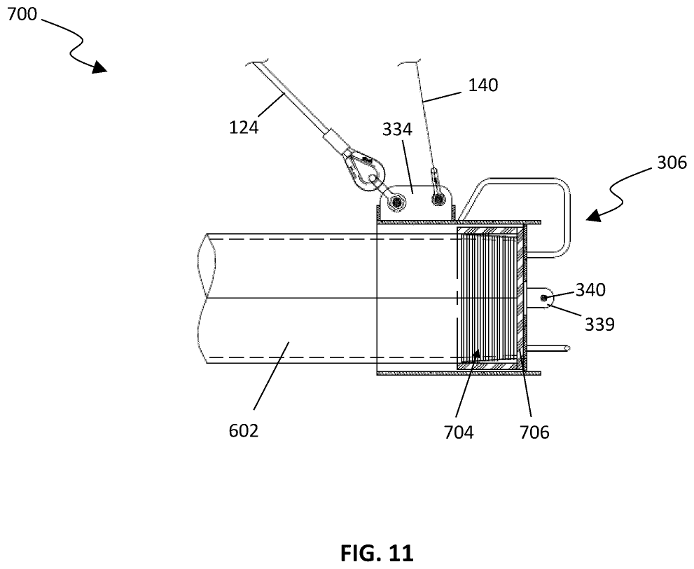

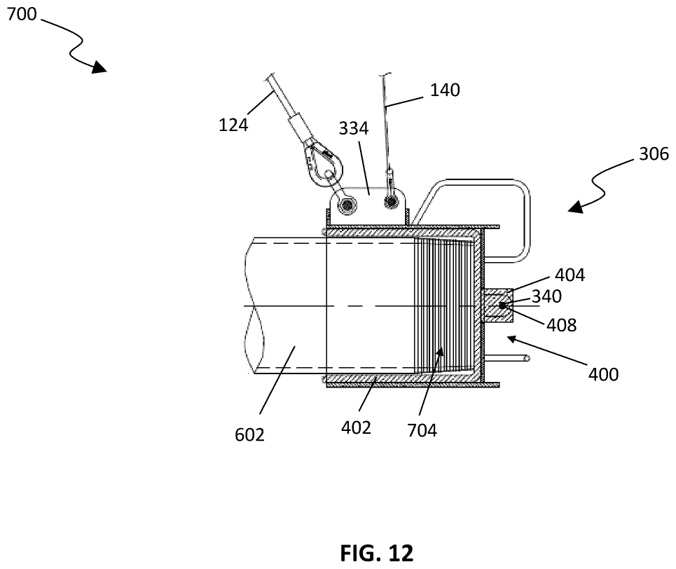

FIG. 11 illustrates an exemplary pin end 700 of the section of drilling casing 602. In the example shown, the pin end 700 of the section of drilling casing 602 includes external threads 704 and an external thread protector 706. As shown, a lifting cap 306 (without the optional sleeve lining) is slidably engaged over the pin end 700 of the section of drilling casing 602, including over the external thread protector 706. A respective elastic stabilizer 140 and sling 124 are also coupled to the lug 334 of the lifting cap 306 engaged over the pin end 700 for coupling to a spreader bar (e.g., such as the spreader bar 200), as previously discussed. FIG. 12 also illustrates the pin end 700 of the section of drilling casing 602. However, in the example of FIG. 12, the pin end 700 of the section of drilling casing 602 does not include an external thread protector. Instead, the polymer sleeve lining 400 is installed within the lifting cap 306, where the main liner body 402 of the sleeve lining 400 is disposed within the lifting cap 306, and where the end portion 404 of the sleeve lining 400 extends out of the opening 342 at the back end of the lifting cap 306. As previously noted, a pin (e.g., such as a safety pin, cotter pin, or other suitable pin) may be inserted through each of the openings 340 of the lugs 339 (protruding from the back end of the lifting cap 306) and the opening 408 of the end portion 404 of the sleeve lining 400 to secure the sleeve lining 400 within the lifting cap 306. The lifting cap 306 (with the optional sleeve lining 400) is then slidably engaged over the pin end 700 of the section of drilling casing 602. A respective elastic stabilizer 140 and sling 124 are also coupled to the lug 334 of the lifting cap 306 (with the optional sleeve lining 400) engaged over the pin end 700 for coupling to a spreader bar (e.g., such as the spreader bar 200), as previously discussed.

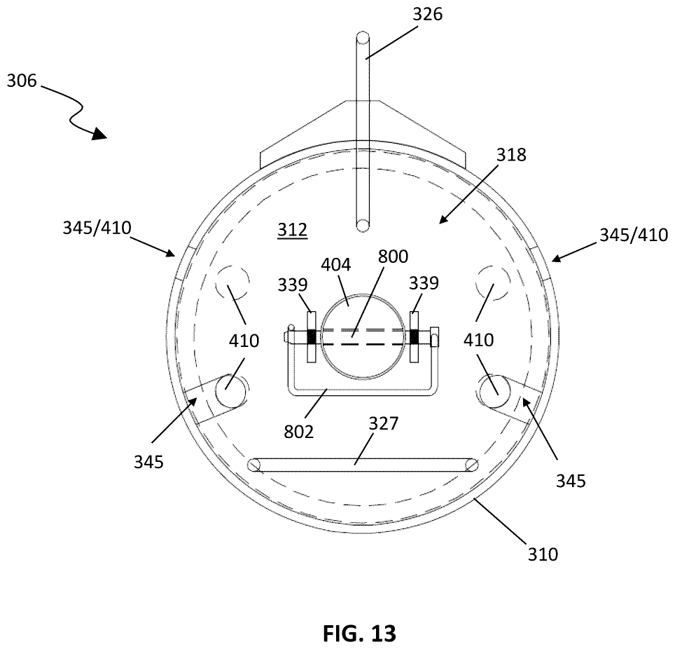

Referring to FIG. 13, illustrated therein is a back-end view of the lifting cap 306, similar to the example of FIG. 7B, but with the polymer sleeve lining 400 installed within the lifting cap 306. As shown, the end portion 404 of the sleeve lining 400 extends out of the opening 342 at the back end of the lifting cap 306. In the present example, the sleeve lining 400 is secured to the lifting cap 306 using a pin 800 that passes through each of the openings 340 of the lugs 339 and the opening 408 of the end portion 404 of the sleeve lining 400. In addition, a retainer clip 802 is coupled to the pin 800 to ensure that the pin 800 stays in place. As previously noted, and in some embodiments, other types of pins may alternatively be used to secure the sleeve lining 400. FIG. 13 also illustrates the plurality of openings 410 in the sleeve lining 400, where inspection windows 345 in the lifting cap 306 are aligned to various ones of the openings 410, thereby allowing the inspection windows 345 to be used for ensuring that the lifting cap 306 is fully engaged (fully seated) on an end of drilling casing.

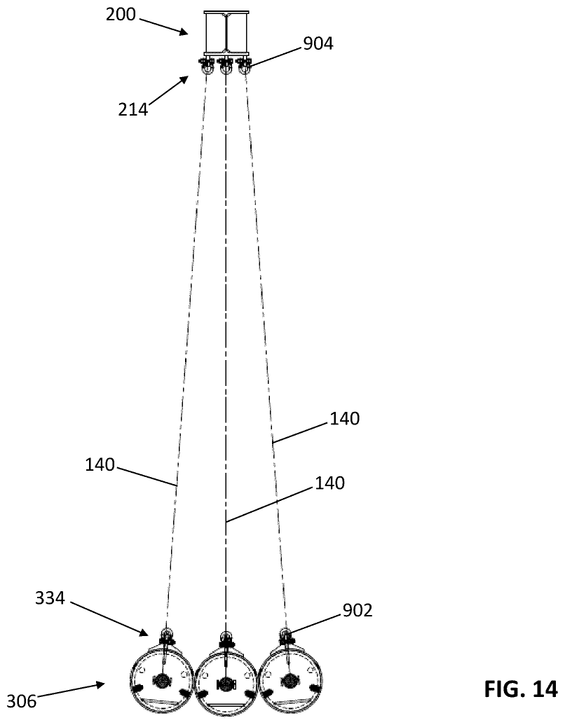

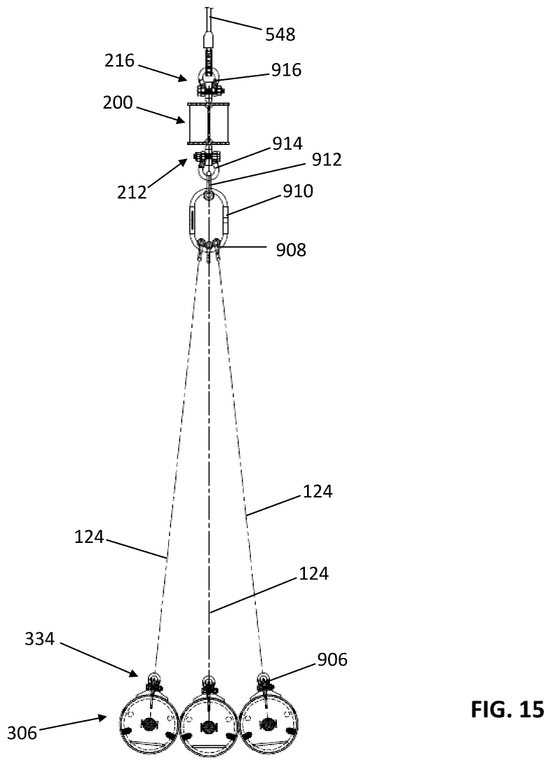

With reference to FIGS. 14 and 15, illustrated therein are end views of portions of a casing lifting system (e.g., such as the casing lifting system 500) configured for lifting three sections of drilling casing. FIG. 14 provides an end view showing three lifting caps 306 (which are coupled to respective sections of drilling casing). FIG. 14 further illustrates the lifting caps 306 coupled to the spreader bar 200 using respective elastic stabilizers 140 coupled between shackles 902 attached to lugs 334 on each of the lifting caps 306 and shackles 904 attached to lugs 214 disposed along the underside of the spreader bar 200. FIG. 15 also provides an end view showing the three lifting caps 306 of FIG. 14. However, FIG. 15 further illustrates the lifting caps 306 coupled to the spreader bar 200 using respective slings 124 coupled between shackles 906 attached to the lugs 334 on each of the lifting caps 306 and shackles 908 attached to a master link 910, further attached to shackles 912, 914 and lug 212 along the underside of the spreader bar 200. FIG. 15 also illustrates a sling 548 for coupling between a master link assembly (e.g., such as the master link assembly 550) and a shackle 916 attached to lug 216 disposed along a topside of the spreader bar 200. In various examples, the shackles used to attach the elastic stabilizers 140 need not have as high of a load capacity as the shackles used to attach the slings 124, which substantially carry the load of the sections of drilling casing. As merely one example, the shackles 902, 904 may have a load capacity of about 1.5 metric tons (MT), the shackle 906 may have a load capacity of about 2MT, the shackle 908 may have a load capacity of about 3.25 MT, the master link 910 may have a load capacity of about 7MT, and the shackles 912, 914, 916 may have a load capacity of about 6.5MT. To be sure, shackles with other load capacities may equally be used, for example, depending on a variety of factors (e.g., such as the number of sections of drilling casing to be lifted, a weight of each of the sections of drilling casing, or other factors).

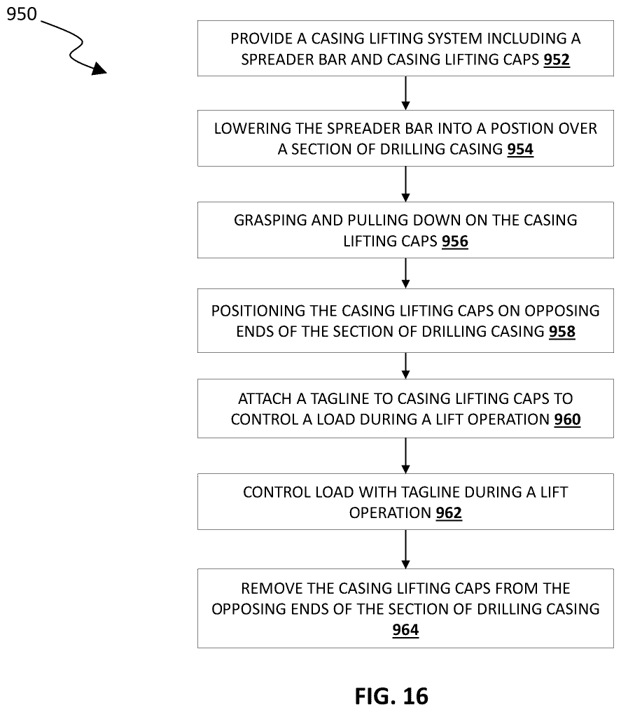

Referring to FIG. 16, illustrated therein is a method 950 of using a casing lifting system, in accordance with embodiments disclosed herein. The method 950 may be implemented using the casing lifting systems 100, 500, described above. Thus, one or more aspects discussed above with reference to the casing lifting systems 100, 500 may also apply to the method 950.

The method 950 begins at block 952 where a casing lifting system including a spreader bar and a pair of casing lifting caps is provided. In various embodiments, the casing lifting system may include the casing lifting systems 100, 500, the spreader bar may include the spreader bars 136, 200, and the lifting caps may include the lifting caps 106, 306, each of which has been described above. In some embodiments, the pair of lifting caps are suspended from ends of the spreader bar by respective elastic stabilizers having a first stabilizer length.

The method 950 proceeds to block 954 where the spreader bar is lowered into a position over a section of drilling casing to be lifted, such that the pair of lifting caps suspended from the ends of the spreader bar by the respective elastic stabilizers are disposed near each of the opposing ends of the section of drilling casing to be lifted. The method 950 then proceeds to block 956 where the pair of lifting caps may be grasped (e.g., by a user such as a roustabout via one of the handles 126, 327, 327) and pulled down such that the respective elastic stabilizers are extended to a second stabilizer length greater than the first stabilizer length. Thereafter, the method 950 proceeds to block 958 where after pulling down on the pair of lifting caps and extending the respective elastic stabilizers, the pair of casing lifting caps are positioned onto opposing ends of the section of drilling casing to be lifted. In addition, the user may utilize the windows in the pair of casing lifting caps to ensure that the section of drilling casing is fully engaged with each of the pair of lifting caps.

The method 950 then proceeds to block 960 where respective taglines are attached, by a breakaway coupling connection, to a recessed end plate portion at a back end of the pair of lifting caps, as previously discussed. The method 950 proceeds to block 962 where during a lift operation, a load (e.g., the section of drilling casing to be lifted) is controlled (e.g., by a user) using the respective taglines. After the lift operation, the method 950 proceeds to block 964 where the pair of lifting caps are removed from the opposing ends of the section of drilling casing. In various embodiments, removing the pair of lifting caps causes the respective elastic stabilizers to retract back to the first stabilizer length.

It will be understood that, in various embodiments, additional steps may be implemented before, during, and/or after the method 950, and some steps may be replaced or eliminated in accordance with various embodiments of the method 950. For example, in some cases, the respective taglines may be attached to the pair of lifting caps prior to positioning the pair of lifting caps onto the opposing ends of the section of drilling casing to be lifted. Further, in some cases, the pair of casing lifting caps may be positioned onto the opposing ends of the section of drilling casing and subsequently removed from opposing ends of the section of drilling casing without actually performing the lift operation. Various other modifications to the method 950 are possible and will become apparent to one skilled in the art having benefit of the present disclosure.

Thus, systems and methods have been provided for lifting a section of drilling casing (or other tubulars) using lifting caps and a spreader bar. In some embodiments, the disclosed casing lifting system includes first and second lifting caps configured for engagement on opposing ends of a section of drilling casing and a spreader bar with an optionally reconfigurable length to accommodate a wider range of casing lengths. Each of the lifting caps may be configured for attachment of a sling for coupling to the spreader bar and for attachment of an elastic stabilizer for coupling to ends of the spreader bar. By integrating the spreader bar and elastic stabilizers, the casing lifting caps remain disposed at ends of the casing and within safe reach of roustabouts. In some examples, the disclosed lifting caps (i) include handles for easy and safe positioning of the casing lifting caps, (ii) are designed to fit over thread protectors, (iii) include side and/or end inspection windows to ensure that the lifting caps are fully engaged on an end of the casing, and (iv) can include an integrated polymer sleeve lining within the lifting cap, in some examples. In various embodiments, the lifting caps are also configured to provide hands-free lifting (e.g., using tangle resistant taglines) and are push stick friendly (e.g., by inclusion of a recessed lip at ends of the lifting caps). The spreader bar may also include feet disposed along an underside of the spreader bar for safely landing the spreader bar. Thus, embodiments of the present disclosure provide a casing lifting system and rigging arrangement that enhances safety and overall efficiency.

The foregoing is not intended to limit the present disclosure to the precise forms or particular fields of use disclosed. As such, it is contemplated that various alternate embodiments and/or modifications to the present disclosure, whether explicitly described or implied herein, are possible. Persons of ordinary skill in the art in possession of the present disclosure will recognize that changes may be made in form and detail without departing from the scope of what is claimed.

What is claimed is:

1. A casing lifting system, comprising:
a spreader bar;
a first lifting cap configured to engage a first end of a first section of drilling casing, the first lifting cap including a first lifting lug; and
a second lifting cap configured to engage a second end of the first section of drilling casing opposite the first end of the first section of drilling casing, the second lifting cap including a second lifting lug;
wherein each of the first and second lifting caps are configured for coupling adjacent to opposing lateral ends of the spreader bar by respective first and second elastic stabilizers coupled between the first and second lifting lugs and first attachment points adjacent to the opposing lateral ends of the spreader bar.

2. The casing lifting system of claim 1,
wherein each of the first and second lifting caps are further configured for coupling to an underside of the spreader bar by respective first and second slings coupled between the first and second lifting lugs and second attachment points along the underside of the spreader bar.

3. The casing lifting system of claim 2,
wherein the first section of drilling casing provides a load, and wherein the first and second slings substantially carry the load.

4. The casing lifting system of claim 2,
wherein the second attachment points are disposed between the first attachment points adjacent to the opposing lateral ends of the spreader bar.

5. The casing lifting system of claim 1,
wherein the first and second elastic stabilizers are configured to keep the first and second lifting caps near the first and second ends of the first section of drilling casing within reach of a user.

6. The casing lifting system of claim 1,
wherein the first and second elastic stabilizers are configured to stretch to a first length when the first and second lifting caps are engaged to respective ones of the first and second ends of the first section of drilling casing; and
wherein the first and second elastic stabilizers configured to retract to a second length shorter than the first length when the first and second lifting caps are not engaged to the respective ones of the first and second ends of the first section of drilling casing.

7. The casing lifting system of claim 1,
wherein the spreader bar further includes third attachment points along a topside of the spreader bar, the third attachment points configured for coupling to a master link assembly by respective first and second lifting slings coupled between the third attachment points and the master link assembly.

8. The casing lifting system of claim 1,
wherein the spreader bar includes a first segment and a second segment coupled using a splice connection.

9. The casing lifting system of claim 1,
wherein the spreader bar includes a spool segment coupled between a first segment and a second segment, the first segment coupled to the spool segment using a first splice connection, and the second segment coupled to the spool segment using a second splice connection.

10. The casing lifting system of claim 1,
wherein at least one of the first and second lifting caps include an annular wall portion and an end plate portion coupled to the annular wall portion at a back end of the at least one of the first and second lifting caps to define an interior space at a front end of the at least one of the first and second lifting caps within which at least one of the first and second ends of the first section of drilling casing is configured to engage the at least one of the first and second lifting caps.

11. The casing lifting system of claim 10,
wherein the end plate portion is recessed at the back end of the at least one of the first and second lifting caps to provide a lip around a perimeter of the back end of the at least one of the first and second lifting caps.

12. The casing lifting system of claim 10,
wherein the at least one of the first and second lifting caps includes a handle coupled to the end plate portion.

13. The casing lifting system of claim 10,
wherein the at least one of the first and second lifting caps are configurable for installation of a sleeve lining disposed within the interior space of the at least one of the first and second lifting caps to define a modified interior space within which at least one of the first and second ends of the first section of drilling casing are configured to engage the at least one of the first and second lifting caps.

14. A casing lifting cap, comprising:
an annular wall portion;
an end plate portion coupled to the annular wall portion near a back end of the casing lifting cap, the annular wall portion and the end plate portion defining an interior space configured to receive an end of a section of drilling casing; and
a lifting lug coupled to the annular wall portion along a top surface of the casing lifting cap, the lifting lug including a first hole and a second hole, the first hole configured for connecting the casing lifting cap to a spreader bar using a sling, and the second hole configured for connecting the casing lifting cap to an end of the spreader bar using an elastic stabilizer.

15. The casing lifting cap of claim 14,
wherein the end plate portion is recessed at the back end of the casing lifting cap to provide a lip around a perimeter of the back end of the casing lifting cap.

16. The casing lifting cap of claim 14,
in combination with and connected to the sling,
wherein the sling is configured to provide a compression force that pulls the casing lifting cap onto the end of the section of drilling casing.

17. The casing lifting cap of claim 14,
in combination with and connected to the elastic stabilizer,
wherein the elastic stabilizer is configured to keep the casing lifting cap near an end of the section of drilling casing and within reach of a user.

18. The casing lifting cap of claim 14, further comprising:
a pair of lugs coupled to and protruding from the end plate portion, each of the pair of lugs including a first opening; and
a second opening in the end plate portion, the second opening interposing the pair of lugs.

19. The casing lifting cap of claim 18,
in combination with a sleeve lining installed within the interior space of the casing lifting cap;
wherein the second opening is configured to receive a protruding end portion of the sleeve lining, the protruding end portion of the sleeve lining including a third opening that is substantially aligned with the first opening of each of the pair of lugs, and the aligned first and third openings configured for insertion of a pin therethrough to secure the sleeve lining within the casing lifting cap.

20. The casing lifting cap of claim 14, further comprising:
inspection windows disposed in the end plate portion or the annular wall portion to ensure that the end of the section of drilling casing is fully engaged with the casing lifting cap.

21. The casing lifting cap of claim 20,
wherein the inspection windows include a first pair of inspection windows disposed in the annular wall portion near the back end of the casing lifting cap and on opposing lateral sides of the casing lifting cap, and a second pair of inspection windows disposed in the end plate portion and adjacent to a perimeter of the end plate portion.

22. The casing lifting cap of claim 20,
in combination with a sleeve lining installed within the interior space of the casing lifting cap;
wherein the inspection windows are aligned with openings in the sleeve lining.

23. A method of using a casing lifting system, comprising:
providing the casing lifting system, the casing lifting system including at least a spreader bar and a pair of lifting caps suspended from ends of the spreader bar by respective elastic stabilizers having a first stabilizer length;
grasping and pulling down on the suspended pair of lifting caps to extend the respective elastic stabilizers to a second stabilizer length greater than the first stabilizer length; and
after extending the respective elastic stabilizers, positioning the pair of lifting caps onto opposing ends of a section of drilling casing.

24. The method of claim 23, further comprising,
removing the pair of lifting caps from the opposing ends of the section of drilling casing, wherein the removing causes the respective elastic stabilizers to retract to the first stabilizer length.

25. The method of claim 23, further comprising,
prior to the grasping and pulling down on the suspended pair of lifting caps, lowering the spreader bar into a position over the section of drilling casing such that the pair of lifting caps suspended from ends of the spreader bar by the respective elastic stabilizers are disposed near each of the opposing ends of the section of drilling casing.

26. The method of claim 23, further comprising,
attaching respective taglines, by a breakaway coupling connection, to a recessed end plate portion at a back end of the pair of lifting caps.
